(19) United States
(12) Patent Application Publication
(10) Pub. No.: US 2008/0086250 A1
(43) Pub. Date: Apr. 10, 2008

(54) Squib driver circuit diagnostic system and method

(75) Inventor: Robert Kuivenhoven, Farmington Hills, MI (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Renesas Technology America, Inc.

(21) Appl. No.: 11/544,912

(22) Filed: Oct. 5, 2006

(51) Int. Cl. B60R 21/16

(52) U.S. Cl. 701/45; 280/735; 180/271

(57) ABSTRACT

A squib driver module comprises a squib circuit for deploying a squib, e.g., in an airbag assembly, the squib circuit including a high side driver and a low side driver in combination for driving a firing signal to the squib; a circuit for activating the firing signal in response to a firing condition; squib diagnostic circuits for conducting diagnostic tests without activating the firing signal and without delivering a diagnostic signal equivalent of the firing signal to the squib, and for generating digital fault information based on the tests; registers for storing the fault information; logic for recognizing a fault condition based on the fault information; and a communication module for communicating the fault condition to a microprocessor unit. The squib diagnostic circuit may include node voltage diagnostic circuits, HSD and/or LSD open/short circuits, HSD and/or LSD driver fault diagnostic circuits, squib-squib short diagnostic circuits, and/or squib resistance diagnostic circuits.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to circuits for activating squibs, and more specifcally to squib diagnostic circuits for testing proper operation of squib circuits, e.g., that deploy an automotive airbag assembly.

### BACKGROUND

A squib is an explosive device that is surrounded by switching elements. When the switching elements are turned on, passing current causes the squib to explode, creating a pressure wave that can be used to operate valves, explode larger charges (for use in weapons and airbag assemblies), move pistons, deploy airbags, activate batteries, deploy wings, close doors, start engines, actuate fuel valves, and so forth.

Authorities have been reluctant to test squibs installed in a device, especially in a military weapon or airbag system, for fear of unintentionally activating the device. Accordingly, there is a need for a squib diagnostic circuits to detect faults with high-level accuracy and without the potential for inadvertent activation.

The main components of an airbag supplemental restraint system used in motor vehicles employ one or more squib circuits. An airbag supplemental restraint system typically includes an inflatable airbag, a propellant source (e.g., sodium azide pellets), a squib to initiate burning of the propellant source, at least one crash sensor, and an electronic control module for determining when to deploy the airbag and for sending a firing signal to the squib. The airbag, propellant, and squib are typically contained in an airbag module (e.g., within a steering wheel for a driver airbag). The crash sensor may be contained separately or within the electronic control module.

In the prior art, the electronic control module may perform some diagnostic monitoring of the supplemental restraint system each time the system is turned on (e.g., every time a vehicle is started) or may occur periodically in normal operation to identify any potential performance problems. When the diagnostic monitoring system learns that the system needs service, a warning light may be illuminated to inform the driver. When performing electrical testing of the squib circuit, care must be taken to avoid deploying the airbag, especially due to the risk of inadvertent personal injury, the cost of replacing an airbag module and the loss of supplemental protection until replacement occurs.

In a typical airbag assembly, the microprocessor control unit (MCU) continuously polls each several squib circuit to determine operational status and identify fault conditions. The MCU controls the diagnostic sequence within each squib circuit via a series of ongoing and repeated microprocessor commands. In response to a command, a squib circuit conducts voltage and/or resistive tests to generate analog results, performs A/D conversions on the analog results to generate digital results, and returns the digital results to the MCU. Analog results may also be returned directly to the MCU in systems where the MCU is capable of A/D conversion. The MCU then conducts further data manipulation to determine if a fault condition on any squib circuit exists. This interaction places a significant overhead on the MCU and internal serial communication bus. As the number of squib circuits increases, MCU and communication bus overhead also increases. Systems and methods that reduce MCU and bus overhead and/or perform diagnostic testing without causing inadvertent activation of a squib are needed.

### SUMMARY

In one embodiment, the present invention provides a squib driver module comprising a squib circuit for deploying a squib, the squib circuit including a high side driver and a low side driver in combination for driving a firing signal to the squib; a control circuit coupled to the squib circuit for activating the firing signal in response to a firing condition by sending an HSD control signal to the high side driver and an LSD control signal to the low side driver; squib diagnostic circuits coupled to the high side driver and to the low side driver for conducting diagnostic tests without activating the firing signal to the squib and without delivering a diagnostic signal equivalent of the firing signal to the squib, the squib diagnostic circuits for generating digital fault information based on the diagnostic tests; diagnostic registers for storing the digital fault information; logic for recognizing a fault condition based on the digital fault information; and a communication module for communicating the fault condition over a communication channel to a microprocessor unit.

The squib may be located in an airbag assembly. The high side driver may include a first transistor; the low side driver may include a second transistor; and the firing signal may include a firing current. The squib diagnostic circuits may include a node voltage status diagnostic circuit for determining whether a node in the squib circuit is operating within a predetermined voltage range. The node voltage status diagnostic circuit may be operative to determine whether a supply voltage coupled to the high side driver is operating within a predetermined supply voltage range. The squib diagnostic circuits may include an HSD open/short diagnostic circuit for using a pull-down device to determine whether the high side driver has an open/short fault. The squib diagnostic circuits may include an LSD open/short diagnostic circuit for using a pull-up device to determine whether the low side driver has an open/short fault. The squib diagnostic circuits may include a high side driver fault diagnostic circuit for disabling the low side driver, for providing a test signal to the high side driver to activate a diagnostic signal through the high side driver, the diagnostic signal being less than a minimum signal to deploy the squib, and for measuring a generated voltage to determine whether the high side driver is functioning properly. The squib driver module may include a second squib circuit for deploying a second squib, and squib diagnostic circuits may include a squib-squib short diagnostic circuit for determining substantially simultaneously with the high side driver fault diagnostic circuit whether a squib-squib short exists. The squib diagnostic circuits may include a low side driver fault diagnostic circuit for disabling the high side driver, for providing a test signal to the low side driver to activate a diagnostic signal through the low side driver, the diagnostic signal being less than a minimum signal to deploy the squib, and for measuring a generated voltage to determine whether the low side driver is functioning properly. The squib driver module may include a second squib circuit for deploying a second squib, and the squib diagnostic circuits may include a squib-squib short diagnostic circuit for determining substantially simultaneously with the low side driver fault diagnostic circuit whether a squib-squib short exists. The squib driver module may include a second squib circuit for deploying a second squib, and the squib diagnostic circuits may include an HSD squib-squib short diagnostic circuit for disabling the low side driver, for providing a test signal to the high side driver to activate a diagnostic signal through the high side driver, and for comparing generated voltages at the first squib and the second squib to determine if a squib-squib short exists. The squib driver module may include a second squib circuit for deploying a second squib, and the squib diagnostic circuits may include an LSD squib-squib short diagnostic circuit for disabling the high side driver, for providing a test signal to the low side driver to activate a diagnostic signal through the low side driver, and for comparing generated voltages at the first squib and the second squib to determine if a squib-squib short exists. The squib diagnostic circuits may include a squib resistance diagnostic circuit for determining whether a squib resistance is within a predetermined squib resistance range. The communication module may include an serial communications module, such as an SPI port. The logic and the communication module may operate to automatically forward the fault condition to the microprocessor unit.

In another embodiment, the present invention provides a method in a squib driver module, the method comprising determining whether a firing condition for deploying a squib has been satisfied; if the firing condition has been satisfied, causing a squib circuit to generate a firing signal to the squib; if the firing condition has not been satisfied, initiating a squib diagnostic circuit coupled to the squib circuit to perform a diagnostic scan of the squib circuit, generating by the squib diagnostic circuit digital diagnostic fault information indicative of a fault status, storing the digital diagnostic fault information in a local register, and sending the fault status to an external microprocessor unit at least if a fault is diagnosed.

The determining whether the firing condition has been satisfied may include receiving an activation signal from a sensor and determining that the local register stores diagnostic fault information indicating no faults. The initiating may occur based on a trigger mode or a free-running mode. The squib diagnostic circuit may include a node voltage status diagnostic circuit, and the generating may include determining whether a node in the squib circuit is operating within a predetermined voltage range. The node may include a supply voltage. The squib diagnostic circuit may include an open/short diagnostic circuit, and the generating may include using a pull-down device to determine whether the squib circuit has an open/short fault. The squib diagnostic circuit may include an open/short diagnostic circuit, and the generating may include using a pull-up device to determine whether the squib circuit has an open/short fault. The squib circuit may include a high side driver and a low side driver in combination for generating the firing signal; the squib diagnostic circuit may include an HSD fault diagnostic circuit; and the generating may include disabling the low side driver, providing a test signal to the high side driver to activate a diagnostic signal through the high side driver, the diagnostic signal being less than a minimum signal to deploy the squib, and measuring a generated voltage to determine whether the high side driver is functioning properly. The squib diagnostic circuit may further include a squib-squib short diagnostic circuit, and the generating may further include using the squib-squib short diagnostic circuit to determine substantially simultaneously with the HSD fault diagnostic circuit whether a squib-squib short exists. The squib circuit may include a high side driver and a low side driver in combination for generating the firing signal; the squib diagnostic circuit may include an LSD fault diagnostic circuit; and the generating may include disabling the high side driver, providing a test signal to the low side driver to activate a diagnostic signal through the low side driver, the diagnostic signal being less than a minimum signal to deploy the squib, and measuring a generated voltage to determine whether the low side driver is functioning properly. The squib diagnostic circuit may further include a squib-squib short diagnostic circuit, and the generating may further include using the squib-squib short diagnostic circuit to determine substantially simultaneously with the LSD fault diagnostic circuit whether a squib-squib short exists. The squib circuit may include a high side driver and a low side driver in combination for generating the firing signal; the squib diagnostic circuit may include an HSD squib-squib short diagnostic circuit; and the generating may include disabling the low side driver, providing a test signal to the high side driver to activate a diagnostic signal through the high side driver, and comparing generated voltages at the squib and a second squib to determine if a squib-squib short exists. The squib circuit may include a high side driver and a low side driver in combination for generating the firing signal; the squib diagnostic circuit may include an LSD squib-squib short diagnostic circuit; and the generating may include disabling the high side driver, providing a test signal to the low side driver to activate a diagnostic signal through the low side driver, and comparing generated voltages at the squib and a second squib to determine if a squib-squib short exists. The squib diagnostic circuit may include a squib resistance diagnostic circuit, and the generating may include determining whether a squib resistance is within a predetermined squib resistance range.

In yet another embodiment, the present invention may provide a squib driver module, comprising means for determining whether a firing condition for deploying a squib has been satisfied; means for causing a squib circuit to generate a firing signal to the squib if the firing condition has been satisfied; means for initiating a squib diagnostic circuit coupled to the squib circuit to perform a diagnostic scan of the squib circuit if the firing condition has not been satisfied, the squib diagnostic circuit for generating by the squib diagnostic circuit digital diagnostic fault information indicative of a fault status; local register means for storing the digital diagnostic fault information; and means for sending the fault status to an external microprocessor unit at least if a fault is diagnosed.

In still another embodiment, the present invention provides an electronic controller module, comprising a microprocessor unit; a squib-controlled device including a squib; a controller for recognizing a firing condition; and a squib driver module coupled to the microprocessor unit and to the squib-controlled device, the squib driver module including a squib circuit for deploying a squib, the squib circuit including a high side driver and a low side driver in combination for driving a firing signal to the squib, a control circuit coupled to the squib circuit for activating the firing signal in response to a firing condition by sending an HSD control signal to the high side driver and an LSD control signal to the low side driver, squib diagnostic circuits coupled to the high side driver and to the low side driver for conducting diagnostic tests without activating the firing signal to the squib and without delivering a diagnostic signal equivalent of the firing signal to the squib, the squib diagnostic circuits for generating digital fault information based on the diagnostic tests, diagnostic registers for storing the digital fault information, logic for recognizing a fault condition based on the digital fault information, and a communication module for communicating the fault condition over a communication channel to a microprocessor unit.

### BRIEF DESCRIPTION OF THE DRAWINGS

FIG. 1 is a block diagram of a portion of an electronic control module for controlling various airbag assemblies, in accordance with an embodiment of the present invention.

FIG. 2 is a block diagram illustrating details of the registers of FIG. 1, in accordance with an embodiment of the present invention.

FIG. 3 is a circuit diagram illustrating details of the error reporting module of FIG. 1, in accordance with an embodiment of the present invention.

FIG. 4A is a circuit diagram illustrating details of the scan mode control register of FIG. 2 and test control module of FIG. 1, in accordance with an embodiment of the present invention.

FIG. 4B is a circuit diagram illustrating details of the test control module of FIG. 1, in accordance with an embodiment of the present invention.

FIG. 5 is a circuit diagram illustrating details of a node voltage status diagnostic circuit, in accordance with an embodiment of the present invention.

FIG. 6A is a circuit diagram illustrating details of the voltage limit register of FIG. 2, in accordance with an embodiment of the present invention.

FIG. 6B is a circuit diagram illustrating details of a voltage limit circuit of FIG. 5, in accordance with an embodiment of the present invention.

FIG. 7A is a circuit diagram illustrating details of a system voltage diagnostic circuit, in accordance with an embodiment of the present invention.

FIG. 7B is a circuit diagram illustrating details of a system voltage status error reporting module of FIG. 1, in accordance with an embodiment of the present invention.

FIG. 8A is a circuit diagram illustrating details of a system voltage limit register of FIG. 2, in accordance with an embodiment of the present invention.

FIG. 8B is a circuit diagram illustrating details of a system voltage limit circuit of the test control module of FIG. 1, in accordance with an embodiment of the present invention.

FIG. 9A is a circuit diagram illustrating details of an open/short diagnostic circuit, in accordance with an embodiment of the present invention.

FIG. 9B is a circuit diagram illustrating details of an open/short error reporting module of FIG. 1, in accordance with an embodiment of the present invention.

FIG. 10A is a circuit diagram illustrating details of an HSD fault and squib-squib short diagnostic circuit, in accordance with an embodiment of the present invention.

FIG. 10B is a circuit diagram illustrating details of an LSD fault and squib-squib short diagnostic circuit, in accordance with an embodiment of the present invention.

FIG. 11A is a circuit diagram illustrating details of an HSD/LSD driver error reporting module of FIG. 1, in accordance with an embodiment of the present invention.

FIG. 11B is a circuit diagram illustrating details of a squib-squib short error reporting module of FIG. 1, in accordance with an embodiment of the present invention.

FIG. 12A is a circuit diagram illustrating details of a squib resistance diagnostic circuit, in accordance with an embodiment of the present invention.

FIG. 12B is a circuit diagram illustrating details of a squib resistance error reporting module of FIG. 1, in accordance with an embodiment of the present invention.

FIG. 13A is a circuit diagram illustrating details of the control input status register of FIG. 2, in accordance with an embodiment of the present invention.

FIG. 13B is a circuit diagram illustrating details of a control input status circuit, in accordance with an embodiment of the present invention.

FIG. 14A is a block diagram illustrating details of the fire current select register of FIG. 2, in accordance with an embodiment of the present invention.

FIG. 14B is a circuit diagram illustrating details of a fire current select circuit, in accordance with an embodiment of the present invention.

FIG. 15A is a block diagram illustrating details of the fire duration registers of FIG. 2, in accordance with an embodiment of the present invention.

FIG. 15B is a circuit diagram illustrating details of a fire duration circuit, in accordance with an embodiment of the present invention.

FIG. 16A is a block diagram illustrating details of the fire counters of FIG. 2, in accordance with an embodiment of the present invention.

FIG. 16B is a circuit diagram illustrating details of a fire counter circuit, in accordance with an embodiment of the present invention.

FIG. 17 is a flowchart illustrating a method of conducting squib driver circuit (loop) diagnostics, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

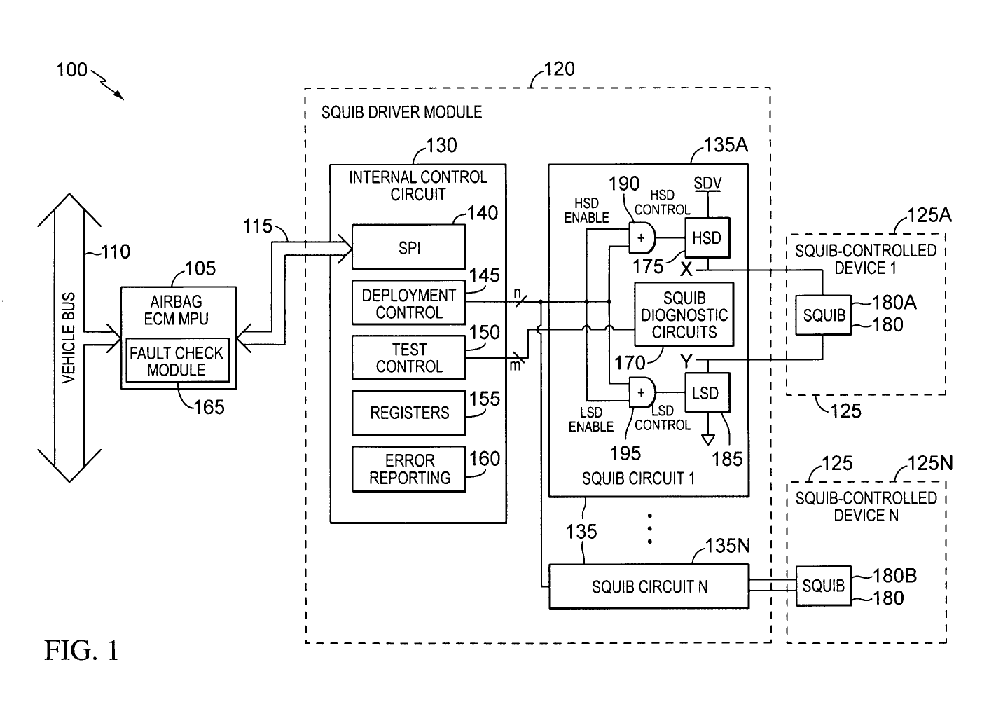

FIG. 1 is a block diagram of an electronic control module (ECM) portion 100 for controlling various airbag assemblies in a vehicle, in accordance with an embodiment of the present invention. The ECM portion 100 includes an airbag ECM microprocessor unit (MPU) 105 communicatively coupled to the vehicle bus 110 and communicatively coupled via a serial communication channel 115 to a squib driver module 120. The squib driver module 120 is communicatively coupled to N squib-controlled devices 125A-125N (each hereinafter referred to generically as “a squib-controlled device 125”). Each squib controlled device 125 may include an airbag assembly of an airbag supplemental restraint system.

The airbag ECM MPU 105 includes a fault check module 165, which is capable of reading and/or receiving diagnostic fault data from fault registers within the squib driver module 120. The diagnostic fault data stored within the fault registers of the squib driver module 120 indicate whether a fault (open, short, resistance value outside a predetermined range, voltage outside a predetermined range, current outside a predetermined range, etc.) has occurred. In one embodiment, the squib driver module 120 initiates sending the diagnostic fault data to the fault check module 165. In another embodiment, the fault check module 165 sends a request for the diagnostic fault data to the squib driver module 120 in response to the satisfaction of predetermined criteria (e.g., the passage of a time interval, the occurrence of a predetermined event, an external request, etc.). The squib driver module 165 then sends the diagnostic fault data to the fault check module 165. The fault check module 165 uses the diagnostic fault data to activate sensors, warning indicators, switches, etc. Other embodiments are also possible.

The squib driver module 120 includes an internal control circuit 130 communicatively coupled via the serial communication channel 115 to the airbag ECM MPU 105 and includes N squib circuits 135A-135N (each hereinafter referred to generically as “squib circuit 135”), each communicatively coupled to the internal control circuit 130 and to a respective one of the N squib-controlled devices 125. For example, the first squib circuit 135A is communicatively coupled to the first squib-controlled device 125A. The N-th squib circuit 135N is communicatively coupled to the N-th squib controlled device 125N. Although in this embodiment each squib circuit 135 is shown and described herein as identical, one skilled in the art will recognize that each squib circuit 135 need not be identical.

The internal control circuit 130 includes a serial peripheral interface (SPI) module 140 communicatively coupled to the serial communication channel 115 for communicating via the serial communication channel 115 with the airbag ECM MPU 105. In one embodiment, the SPI module 140 is the Motorola serial peripheral interface for data communication. In another embodiment, the SPI module 140 is the Renesas SPI (RSPI) designed by Renesas Corporation, which is compatible with the Motorola SPI. Each of the other components of the internal control circuit 130, e.g., the registers 155 discussed below, may be communicatively coupled to the SPI module 140 to send and receive data. Other serial communication methods are possible.

The internal control circuit 130 also includes a deployment control module 145. The deployment control module 145 may include internal controllers and/or communicate with external controllers. The internal and/or external controllers may include component-controlled or user-controlled switches. Internal and/or external controllers may include various crash sensors for recognizing front-end, left-side and right-side vehicle collisions. Based on the internal and/or external controllers, the deployment control module 145 may deploy airbags, control valves, move pistons, activate batteries, deploy wings, close doors, start engines, actuate fuel valves, etc. The deployment control module 145 may be coupled to control each of the squib circuits 135 individually to deploy relevant squibs in response to the signals from the internal and/or external controllers. That way, for example, in response to a left-side crash, only airbags relevant to a left-side crash will be activated.

The internal control circuit 130 also includes a test control module 150. The test control module 150 includes circuits for initiating squib diagnostic testing (by the squib diagnostic circuits 170 discussed below), gathering squib diagnostic fault data from the squib diagnostic circuits 170, and writing the squib diagnostic fault data to the registers 155. The test control module 140 may initiate squib diagnostic testing based on control data stored in the registers 155.

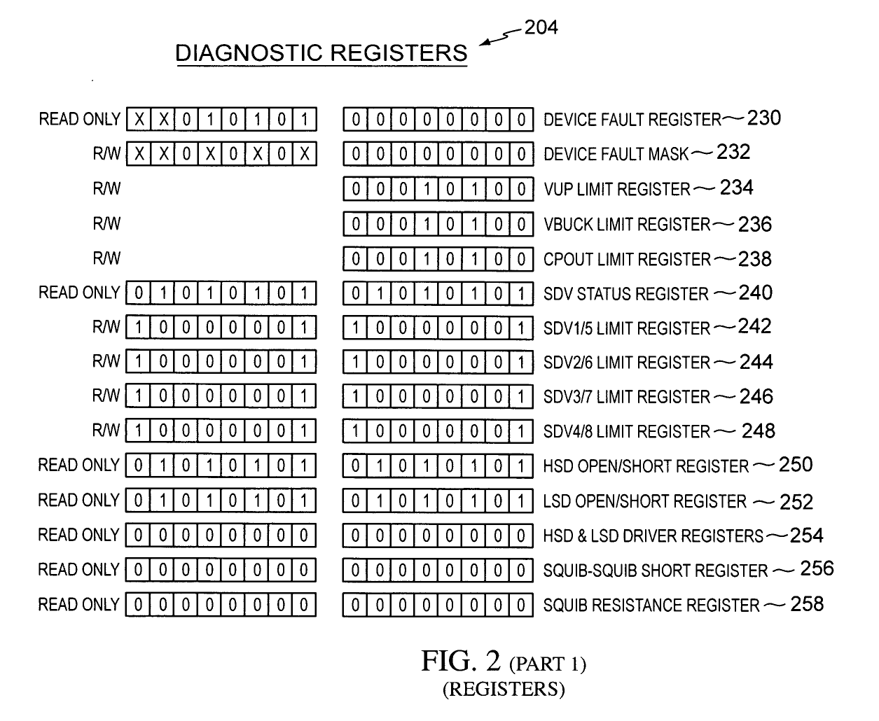

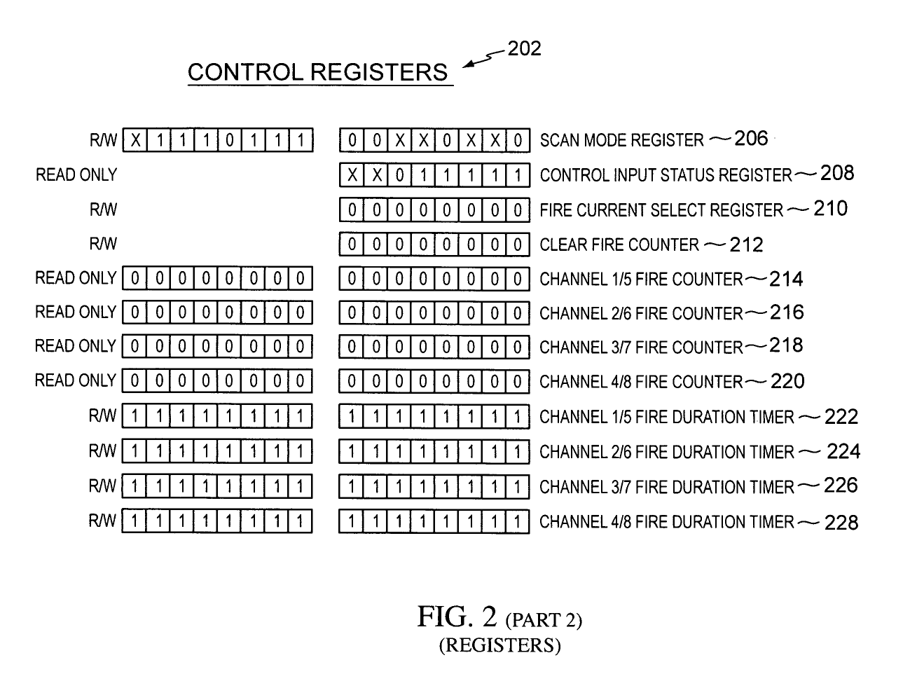

The internal control circuit 130 also includes registers 155. In one embodiment, the registers 155 include control registers for controlling the behavior of the squib circuits 135 and controlling initiation of the squib diagnostic circuits 170. The registers 155 also include diagnostic registers, such as limit registers for controlling threshold values of the squib diagnostic circuits 170 and diagnostic fault-storage registers for storing diagnostic fault data generated by the squib diagnostic circuits 170. Example registers 155 are shown and described with reference to FIG. 2.

The internal control circuit 130 also includes an error reporting module 160. The error reporting module 160 reviews the diagnostic fault data stored in the diagnostic fault-storage registers of the registers 155. Based on the diagnostic fault data, the error reporting module 165 informs the fault check module 165 of the airbag ECM MPU 165. In one embodiment, the error reporting module 160 initiates sending the diagnostic fault data to the fault check module 165 upon the detection of a fault or upon the satisfaction of predetermined criteria (e.g., the passage of a time interval, the occurrence of a predetermined event, an external request, etc.). In another embodiment, the error reporting module 160 waits for a request for diagnostic fault data from the fault check module 165. In response to a request, the error reporting module 160 sends the diagnostic fault data to the fault check module 165.

Control and interpretation of the diagnostic fault data may be continuously performed on the squib driver module 120, instead of being controlled and analyzed by the airbag ECM MCU 105. Thus, if a fault occurs, an error pin in a register 155 may be activated to signal the airbag ECM MCU 105 that a fault has occurred and that intervention by the airbag ECM MCU 105 may be required. By compiling diagnostic fault data into a single fault register 155, MCU 105 and bus communication channel 115 overhead may be significantly reduced. It will be appreciated that the reductions allowed by an interrupt-driven system can also be realized in polled-type systems.

As shown, each squib circuit 135 includes a high side driver (HSD) 175 and a low side driver (LSD) 185 coupled for controlling test or deployment current to the corresponding squib 180 embedded in the corresponding squib-controlled device 125. In one embodiment, the high side driver 175 includes a first gated transistor (e.g., MOSFET) serially coupled (directly or indirectly) to drive current to the squib 180. The low side driver 185 includes a second gated transistor (e.g., MOSFET) serially coupled (directly or indirectly) to receive current from the squib 180. Both the high side driver 175 and low side driver 185 must be active to drive current through and thus activate the squib 180 (unless a fault exists). In one embodiment, the high side driver 175 receives an HSD control signal that may be the result of an HSD control circuit 190, e.g., an AND gate 190, that receives multiple enable signals, e.g., an HSD enable signal and a no-fault-detected signal. The low side driver 175 receives an LSD control signal that may be the result of an LSD control circuit 195, e.g., an AND gate 195, that receives multiple enable signals, e.g., an LSD enable signal and a no-fault-detected signal. The HSD enable and LSD enable signals may be generated by the internal controllers of the deployment control module 145 and/or external controllers in communication with the deployment control module 145. The no-fault-detected signal may be generated by the squib diagnostic circuits 170 described below and obtained from the diagnostic registers of the registers 155. As stated above, each squib circuit 135 need not be identical.

One or more squib diagnostic circuits 170 may be attached to specific nodes and/or in series with various components of the squib circuit 135. The squib diagnostic circuits 170 may monitor system voltages (such as battery voltage, logic voltage, charge pump voltage and reserve capacity voltage), monitor firing voltage for each high side driver 175 to ensure that it is within acceptable limits, monitor squib connection pins on a scanned basis for open and short conditions, monitor shorts to both ground and supply voltages, etc. The squib diagnostic circuits 170 may simultaneously scan all high side pins, followed by simultaneous scanning all low side pins. An open or short on any pin generates a fault condition. The squib diagnostic circuits 170 may monitor high side and/or low side driver circuits 175 and/or 185 on a scanned basis for proper operation. The squib diagnostic circuits 170 may test high side and low side drivers of each channel (squib circuit) individually. Failure to pass current will generate a fault condition. The squib diagnostic circuits 170 may monitor the non-tested driver output pins during the high side and low side driver circuit tests. Any indication of current at non-tested output pins may indicate that a squib-squib (loop-loop) short condition exists, and will generate a fault. The squib diagnostic circuits 170 may monitor squib resistance to confirm that the integrity of each squib 180 is within acceptable resistance limits for proper firing operation. If squib resistance falls outside of the high or low limit, the diagnostic squib circuits 170 will generate a fault. The details of the squib diagnostic circuits 170 are described below with reference to the various drawings and descriptions.

FIG. 2 is a block diagram illustrating details of the registers 155, in accordance with an embodiment of the present invention. The registers 155 include control registers 205 and diagnostic registers 210. The control registers 205 include a scan mode register 206, a control input status register 208, a fire current select register 210, a clear fire counter 212, a channel 1/5 fire counter 214, a channel 2/6 fire counter 216, a channel 3/7 fire counter 218, a channel 4/8 fire counter 220, a channel 1/5 fire duration timer 222, a channel 2/6 fire duration timer 224, a channel 3/7 fire duration timer 226, and a channel 4/8 fire duration timer 228. The diagnostic registers 204 include a device fault register 230, a device fault mask register 232, a VUP limit register 234, a VBUCK limit register 236, a CPOUT limit register 238, an SDV status register 240, an SDV 1/5 limit register 242, an SDV 2/6 limit register 244, an SDV 3/7 limit register 246, an SDV 4/8 limit register 248, an HSD open/short register 250, an LSD open/short register 252, HSD & LSD driver registers 254, squib-squib short register 256, and a squib resistance register 258. As will be readily recognizable to one skilled in the art, the diagnostic registers 204 include diagnostic limit registers (e.g., 234, 236, 238, 242, 244, 246, 248) that define limits for the diagnostic test circuits 170 and diagnostic fault-storage registers (e.g., 230, 240, 250, 253, 254, 256, 258) for storing diagnostic fault data generated by the squib diagnostic circuits 170. The quantity, data width, order and organization of the fire counter and limit registers may vary with the application.

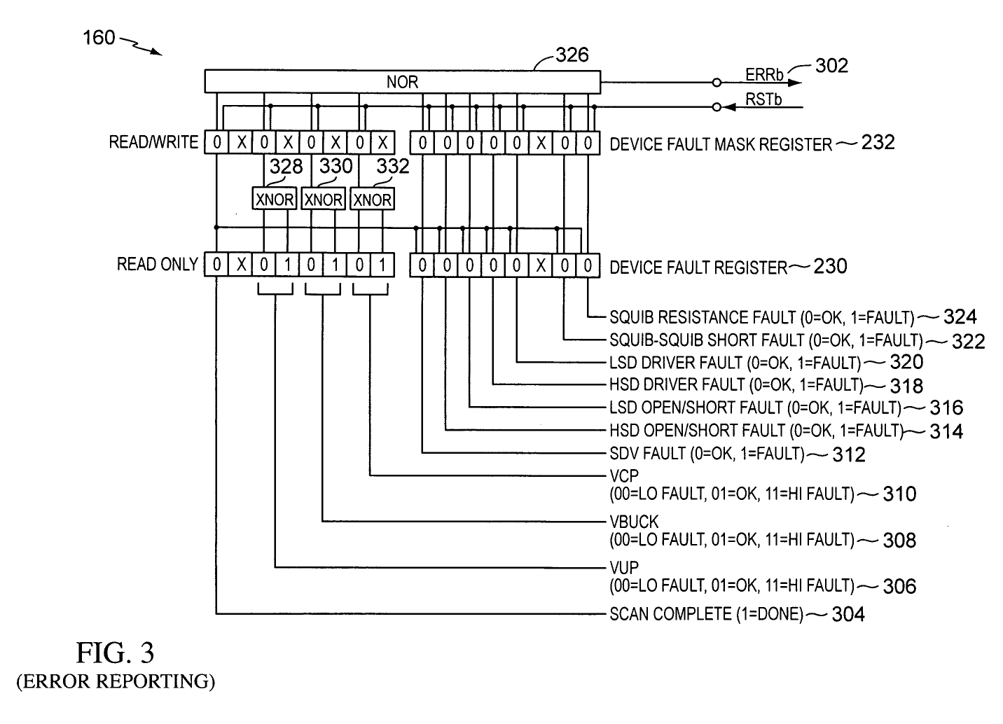

FIG. 3 is a circuit diagram illustrating details of the error reporting module 160, in accordance with an embodiment of the present invention. The error reporting module 160 performs logical functions on the diagnostic fault data stored in the device fault register 230 and the mask data in the device fault mask register 232 to generate a single fault error bit ERRb 302 indicative of whether a fault generally has occurred. The error reporting module 160 sends the fault error bit ERRb 302 to the fault check module 165. The device fault mask register 232 may mask the results during reset and firing. Individual device fault bits may be masked by setting the appropriate bit in the mask register 232. The device fault register 230 may be read only, e.g., SPI commands cannot write to the register. The device fault mask register 232 may be read-write, e.g., SPI commands can write to the register, possibly to control limits, modes, durations, inhibits, etc.

The diagnostic fault data in the device fault register 230 includes a scan complete bit 304 (1=done), a VUP fault bit pair 306 (00=lo fault, 01=ok, 11=hi fault), a VBUCK fault bit pair 308 (00=lo fault, 01=ok, 11=hi fault), a VCP fault bit pair 310 (00=lo fault, 01=ok, 11=hi fault), an SDV fault bit 312 (0=ok, 1=fault), an HSD open/short fault bit 314 (0=ok, 1=fault), an LSD open/short fault bit 316 (0=ok, 1=fault), an HSD fault bit 318 (0=ok, 1=fault), an LSD fault bit 320 (0=ok, 1=fault), a squib-squib short fault bit 322 (0=ok, 1=fault), and a squib resistance fault bit 324 (0=ok, 1=fault).

In the illustrated embodiment, the error reporting module 160 combines the diagnostic fault data with the device fault mask data and uses a NOR gate 326 to perform a logical NOR function of the resulting bits to generate the ERRb 302 indicative of whether at least one fault generally exists. The error reporting module may use XNOR gates 328, 330 and 332 to perform a logical XNOR function on each VUP, VBUCK and VCP bit pair 306-310 to identify a fault by a single bit. That is, by performing an XNOR function on the bit pair, a 01 (ok) is translated to a 0 to represent no fault, and both a 00 (lo fault) and 11 (hi fault) are translated to a 1 to represent a fault generally (regardless of high/low type).

The system voltage diagnostics (VUP, VBUCK and VCP) may be performed in real time. The loop (i.e., squib circuit 135) diagnostics may be updated only upon assertion of the scan complete flag.

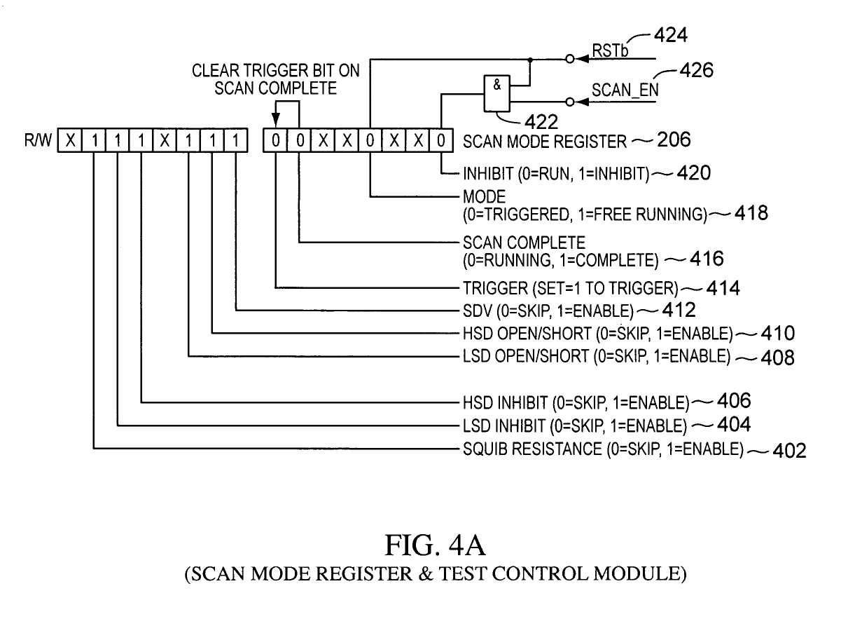

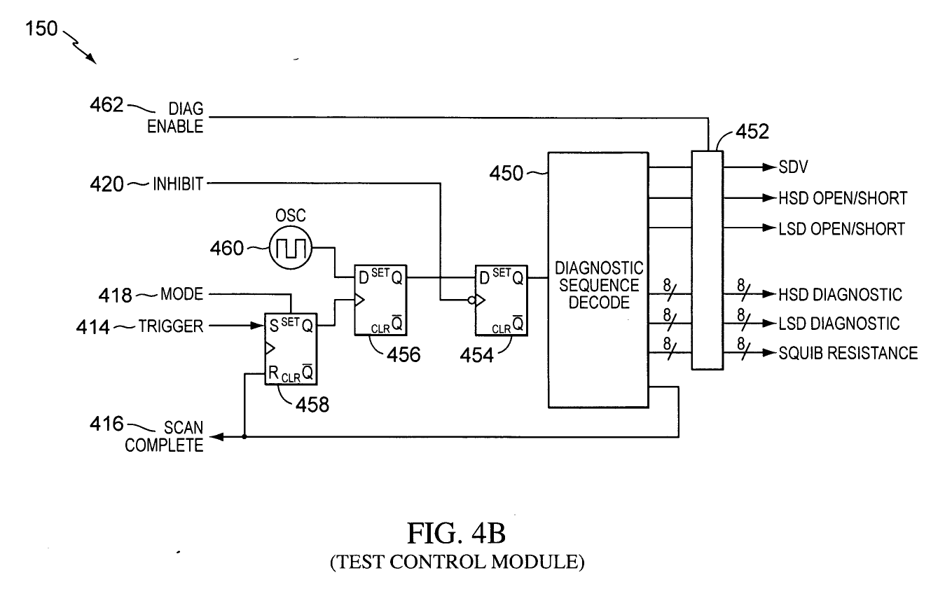

FIG. 4A is a circuit diagram illustrating details of the scan mode register 206, in accordance with an embodiment of the present invention. The scan data in the scan mode register 206 selects different scan modes. The scan mode register 206 includes a squib resistance bit 402 (0=skip, 1=enable), LSD inhibit bit 404 (0=skip, 1=enable), an HSD inhibit bit 406 (0=skip, 1=enable), an LSD open/short bit 408 (0=skip, 1=enable), an HSD open/short bit 410 (0=skip, 1=enable), an SDV bit 412 (0=skip, 1=enable), a trigger bit 414 (set=1 to trigger), a scan complete bit 416 (0=running, 1=complete), a scan mode bit 418 (0=triggered, 1=free running), and an inhibit bit 420 (0=run, 1=inhibit).

The scan mode register 206 may include an AND gate 422 that performs a logical AND function on a RESET bit 424 and a SCAN_EN bit 426 to control the inhibit bit 420. The RESET bit 424 may control the scan mode bit 418 to select between triggered and free running modes. The scan complete bit 416 may control the trigger bit 414 to clear when a scan has completed. Accordingly, the test control module 150 can operate in either triggered mode (a single scan initiated via an SPI command) or free running mode. In either mode, a diagnostic scan by the test control module 150 can be interrupted at any point by de-asserting the SCAN_EN bit 426 or by issuing a scan inhibit command via SPI. Individual diagnostic sequences can be disabled using the scan mode register 206. The diagnostic sequence can be adjusted using the device fault mask register 232.

FIG. 4B is a circuit diagram illustrating details of the test control module 150, in accordance with an embodiment of the present invention. The test control module 150 includes a diagnostic sequence decoder 450 that outputs control signals to initiate and control squib diagnostic circuits, for example, to test for SDV, HSD open/short, LSD open/short, HSD diagnostic, LSD diagnostic, squib-squib short, and squib resistance faults. The diagnostic sequence decoder 450 may be coupled to a logic block 452 that is controlled by a diagnostic enable signal 462 (comprised of the squib resistance bit 402, the LSD inhibit bit 404, the HSD inhibit bit 406, the LSD open/short bit 408, the HSD open/short bit 410, and the SDV bit 412) that individually enables or inhibits each of the activation control signals from being sent to the various squib diagnostic circuits 170.

The diagnostic sequence decoder 450 may be controlled by logic elements with input signals including the scan mode data in the scan mode register 206. An RS flip flop 458 receives the scan complete bit 416 at its R input, the trigger bit 414 at its S input, and the scan mode bit 418 at its control input. Thus, the RS flip flop 458 controls whether the test control module 160 operates in trigger mode or free running mode. A first D flip flop 456 receives the output from the RS flip flop 458 at its control input and an oscillator signal from an oscillator 460 at its D input. Thus, the first D flip flop 456 triggers diagnostic testing in a synchronous manner with the clock. A second D flip flop 454 receives the output of the first D flip flop 456 at its D input and receives the inhibit bit 420 at its control input. Thus, the entire set of diagnostic sequences can be deactivated by a single bit, namely, the inhibit bit 420.

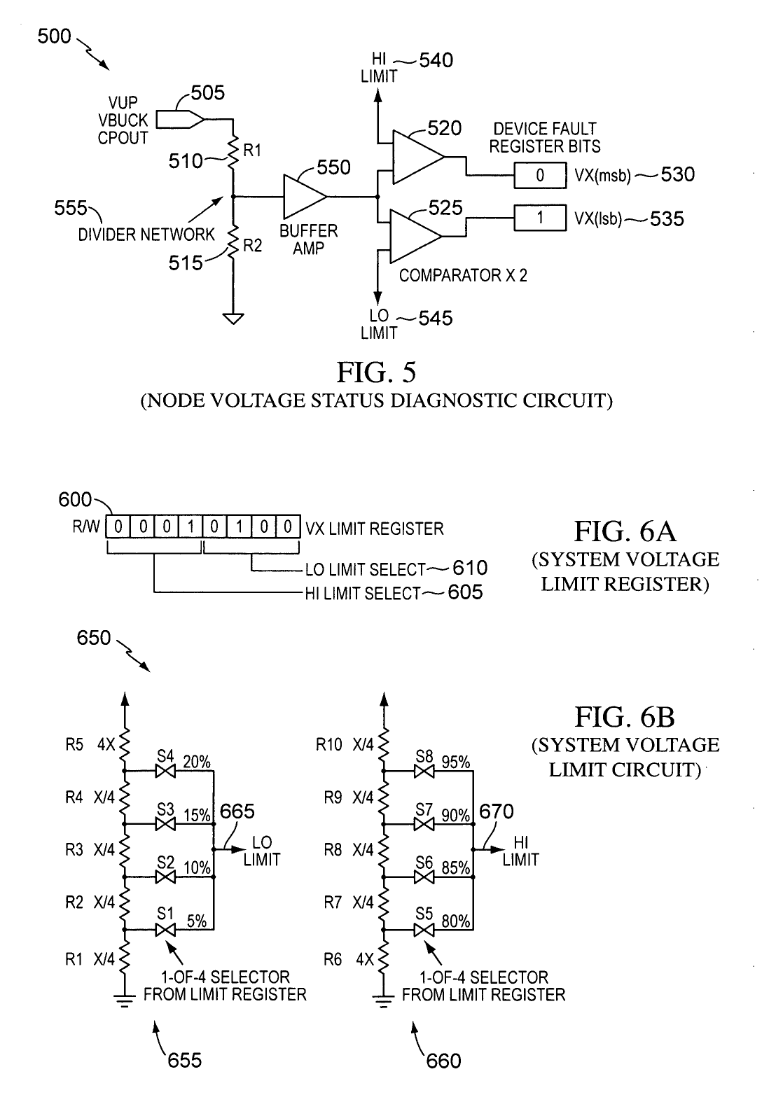

FIG. 5 is a circuit diagram illustrating details of a node voltage status diagnostic circuit 500 of the squib diagnostic circuits 170, in accordance with an embodiment of the present invention. Using the node voltage status diagnostic circuit 500, system voltage, e.g., battery voltage, logic voltage, charge pump voltage, etc., may be monitored on a continuous basis and may generate a fault condition if the monitored voltage is outside an acceptable range. The node voltage status diagnostic circuit 500 includes an input node 505 coupled to a divider network 555 comprised of a first Resister R1 520 coupled in series to a second resistor R2 515. The node voltage status diagnostic circuit 500 further includes two comparators 520 and 525. The first comparator 520 compares the voltage between the resistors R1 and R2 against a high limit (“HI Limit”) 540 to generate a high fault status bit of logic level 0 voltage (“VX(msb)”) when no high fault exists. The second comparator 525 compares the voltage between the resistors R1 and R2 against a low limit (“LO Limit”) 545 to generate a low fault status bit of logic level 1 (“VX(lsb)”) when no low fault exists. Accordingly, in this embodiment, a 01 value represents no fault, a 00 value indicates a low fault, and a 11 value indicates a high fault.

Instances of the node voltage status diagnostic circuit 500 can be placed in various nodes within the squib circuit 135, e.g., to test the SDV, the HSD input voltage, the LSD input voltage, VUP, VBUCK, VCP, etc. VUP is a boosted voltage, usually 24V or 32V, that may be used as a source for the SDV voltage. Note that SDV does not have to be connected to VUP; SDV may be connected to another suitable supply voltage, such as a battery. VBUCK is an intermediate voltage derived from VUP, and may be used as a source for a 5V supply regulator. VBUCK can also be used for satellite devices or communication interfaces that need a voltage supply between 5V and VUP. CPOUT and VCP are essentially the same thing. One characteristic of FET-type transistors is that the gate must be driven higher than the source for efficient, low dissipation operation. In the illustrated embodiment, the FET source (SDV) may be connected to the highest voltage in the system (VUP). Accordingly, a charge pump circuit may be included to provide a yet higher voltage CPOUT/VCP for the gate pull-up function. In one embodiment, the firing voltages may be measured at each high side driver simultaneously on a scanned basis. It will be appreciated that the high and low limits 540 and 545 are programmable as discussed below.

FIG. 6A is a circuit diagram illustrating details of a voltage limit register 600, e.g., VUP limit register 234, VBUCK limit register 236 and/or CPOUT limit register 238, in accordance with an embodiment of the present invention. The voltage limit register 600 is preferably read/write so that high and low limits may be programmable. As shown, the first four bits (e.g., “0001”) of the register 600 define the high limit 540 and are referred to as the “high limit select” 605 and the second four bits (e.g., “0100”) of the register 600 define the low limit 545 and are referred to as the “low limit select” 610. The voltage limit circuit that uses these bits is discussed below.

FIG. 6B is a circuit diagram illustrating details of a voltage limit circuit 650 used by the node voltage status diagnostic circuit 500, in accordance with an embodiment of the present invention. The voltage limit circuit 650 is comprised of a low limit circuit 655 and a high limit circuit 660. The low limit circuit 655 includes five (5) resistors R1-R5 in series, each of the four (4) nodes between a respective pair of serial resistors being switchably connectable via a respective switch S1-S4 to an output node 665 that provides the low limit 545 to the node voltage status diagnostic circuit 500. In one embodiment, the resistor values of R1-R4 may be selected to equal a value x/4. The resistor value of R5 may be selected to equal 4x. Thus, the values at each of the nodes between the pair of serial resistors start at 0.05x, 0.10x, 0.15x and 0.20x. The low limit select value in the second four bits of the register 600 control activation of the switches S1-S4. Thus, a value of “0100” as the low limit select may activate S3, thereby setting the low limit 545 to 0.15x. Similarly, high limit circuit 660 includes five (5) resistors R6-R10 in series, each of the four (4) nodes between a respective pair of serial resistors being switchably connectable via a respective switch S5-S8 to an output node 670 that provides the high limit 540 to the node voltage status diagnostic circuit 500. In one embodiment, the resistor values of R7-R10 may be selected to equal a value x/4. The resistor value of R6 may be selected to equal 4x. Thus, the values at each of the nodes between the pair of serial resistors start at 0.80x, 0.85x, 0.90x and 0.95x. The high limit select value in the first four bits of the register 600 control activation of the switches S5-S8. Thus, a value of “0001” as the high limit select may activate S5, thereby setting the high limit 540 to 0.80x. Resistor values may be adjusted to adjust resolution and limits as needed.

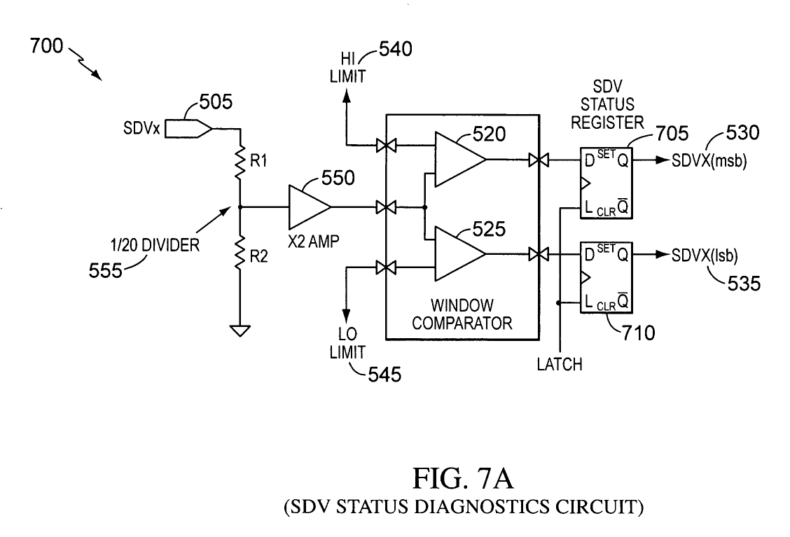

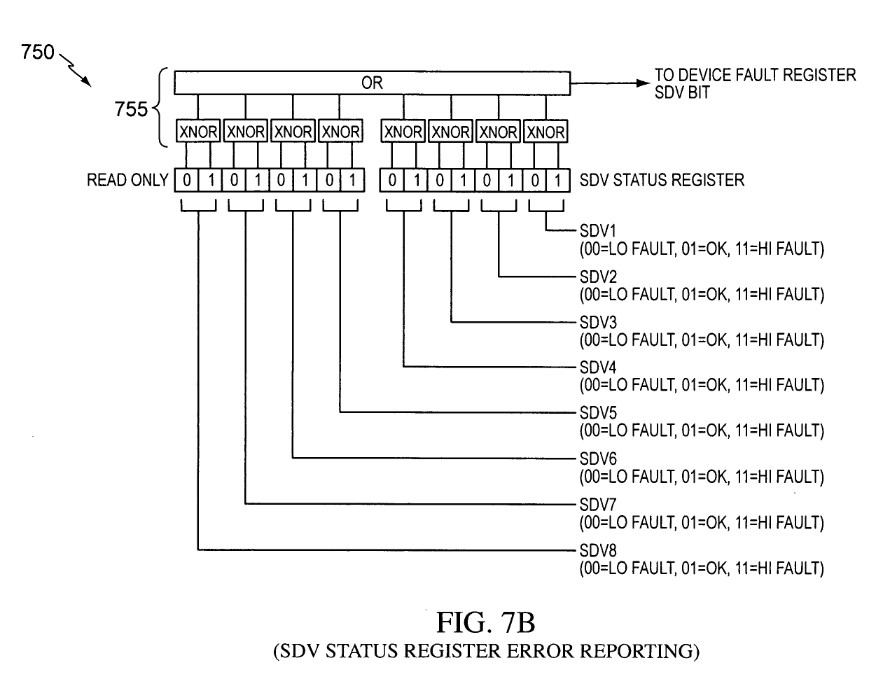

FIG. 7A is a circuit diagram illustrating details of a system voltage diagnostic circuit 700 of the squib diagnostic circuits 170, in accordance with an embodiment of the present invention. The system voltage diagnostic circuit 700 includes a circuit configured and operative similar to the node voltage status diagnostic circuit 500. Accordingly, the similar elements are labeled with the same element reference numbers. In one embodiment, the R1 and R2 values of the voltage divider 555 may be selected for a 1/20 ratio and the amplifier gain set at 2. In one embodiment, a voltage diagnostic circuit 700 is coupled to each of the squib circuits 135 (e.g., eight squib circuits 135), so that all circuits 135 can be checked simultaneously. The latches 705 and 710 may be used to latch the device fault register bits simultaneously into a diagnostic register 204, e.g., the SDV status register 240. The latch 705 may store the high fault status bit, and the latch 710 may store the low fault status bit.

FIG. 7B is a circuit diagram illustrating details of a system voltage status error reporting module 750, in accordance with an embodiment of the present invention. The system voltage status error reporting module 750 includes logic 755 connected to the SDV status register 240. As stated above, the SDV voltage register 240 stores the pairs of SDV low and high fault status bits for all squib circuits 135, namely, SDV1-SDV8 (wherein as stated above 00=lo fault, 01=ok, and 11=hi fault). The logic 755 includes an XNOR gate for performing a logical XNOR function on each pair of SDV low and high fault bits to generate a single bit indicative of an SDV error generally within the corresponding squib circuit 135, regardless of fault type. The output of each XNOR gate is coupled to an OR gate to perform a logical OR function to generate a single bit indicative of a SDV fault generally in any of the squib circuits 135, regardless of the identify of the squib circuit 135. The output of the OR gate is coupled to the device fault register 230.

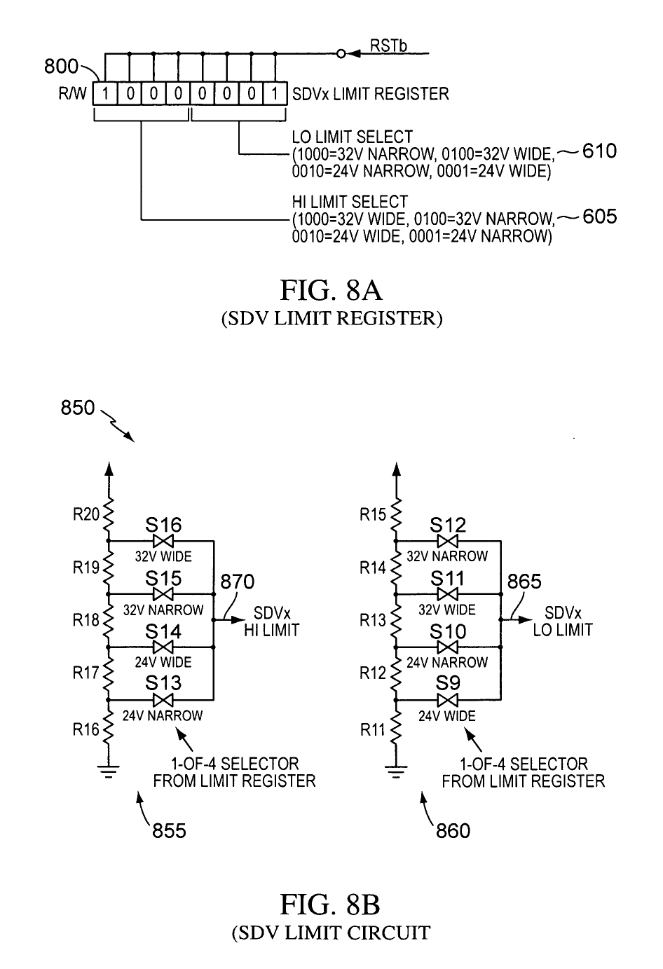

FIG. 8A is a circuit diagram illustrating details of a system voltage limit register 800, e.g., SDV 1/5 limit register 242, SDV 2/6 limit register 244, SDV 3/7 limit register 246 and/or SDV 4/8 limit register 248, in accordance with an embodiment of the present invention. The system voltage limit register 800 is similar physically and operatively to the VX limit register 600. Accordingly, the similar elements are labeled with the same element reference numbers. The voltage limit register 800 is preferably read/write so that high and low limits may be programmable. As shown, the first four bits (e.g., “1000”) of the register 800 define the high limit 540 and are referred to as the “high limit select” 605 and the second four bits (e.g., “0001”) of the register 800 define the low limit 545 and are referred to as the “low limit select” 610. The voltage limit circuit that uses these bits is discussed below. In one embodiment, the hi and lo limits may be programmable for 24V or 32V nominal operation.

FIG. 8B is a circuit diagram illustrating details of a system voltage limit circuit 850 of the system voltage diagnostic circuit 700, in accordance with an embodiment of the present invention. The system voltage limit circuit 850 is comprised of a high limit circuit 855 and a low limit circuit 860. The low limit circuit 860 includes five (5) resistors R11-R15 in series, each of the four (4) nodes between a respective pair of serial resistors being switchably connectable via a respective switch S9-S12 to an output node 865 that provides the low limit 545 to the SDV status diagnostic circuit 700. In one embodiment, the resistor values R1-R15 are selected to provide 24V Wide, 24V Narrow, 32V Wide and 32V Narrow output options. The low limit select value in the second four bits of the register 800 control activation of the switches S9-S12. Thus, a value of “0001” as the low limit select may activate 24V Wide. Similarly, the high limit circuit 855 includes five (5) resistors R16-R20 in series, each of the four (4) nodes between a respective pair of serial resistors being switchably connectable via a respective switch S13-S16 to an output node 870 that provides the high limit 540 to the SDV status diagnostic circuit 700. In one embodiment, the resistor values of R16-R20 may be selected to provide 24V Narrow, 24V Wide, 32V Narrow and 32V Wide output choices. The high limit select value in the first four bits of the register 800 control activation of the switches S13-S16. Thus, a value of “1000” as the high limit select may activate S16, thereby setting the high limit 540 to 32V Wide. Resistor values may be adjusted to adjust resolution and limits as needed.

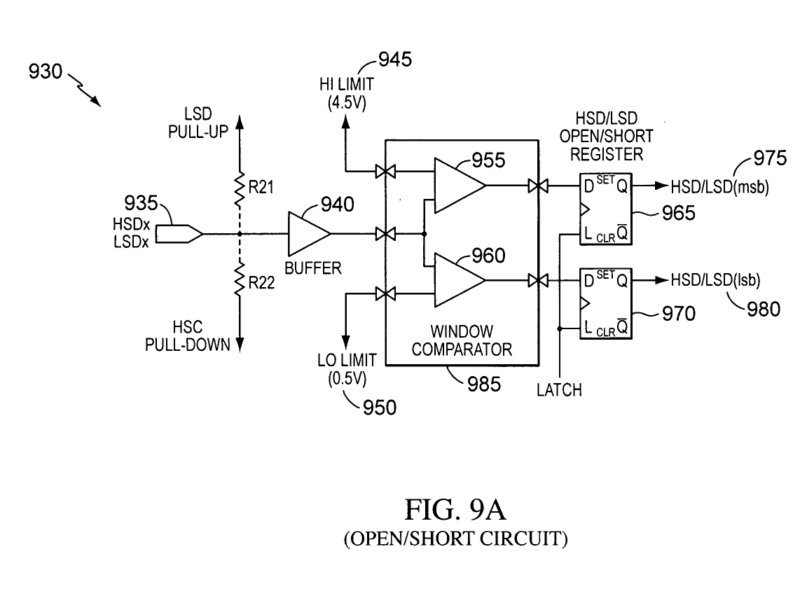

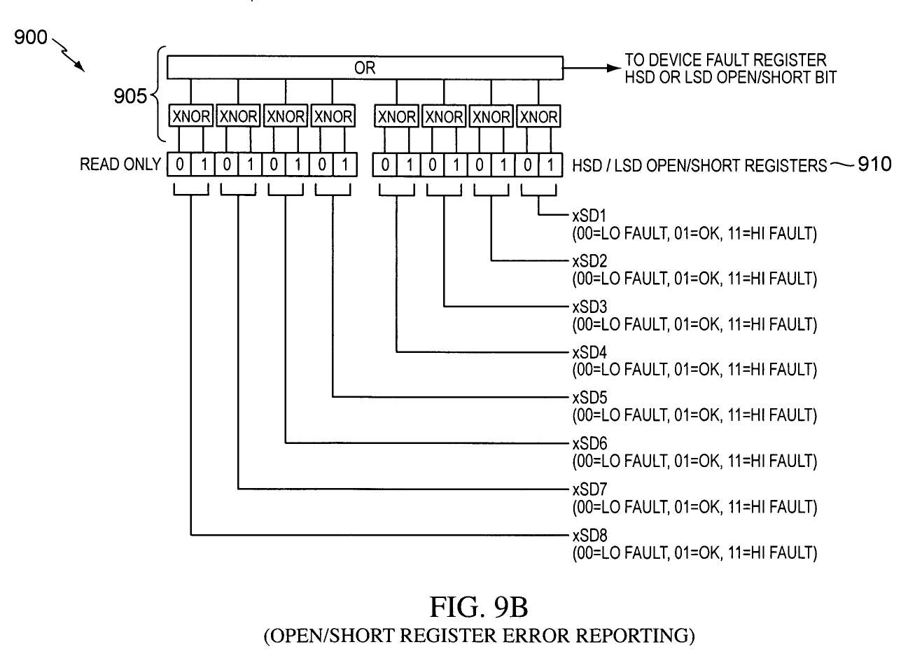

FIG. 9A is a circuit diagram illustrating details of an open/short diagnostic circuit 930 of the squib diagnostic circuits 170, in accordance with an embodiment of the present invention. For testing the high side driver 175, the open/short diagnostic circuit 930 includes an HSD node 935 coupled in parallel to an HSD pull-down resistor R22 (with the LSD pull-up resistor R21 shown in the figure connected through the squib resistance via the LSD node) and to a window comparator 985 comprised of two comparators 955 and 960. The comparator 955 compares the voltage at the HSD node 935 with a high limit 945 (possibly a fixed voltage relative to SDV, e.g., 4.5V) to generate an high fault bit of, for example, logical level 0 if no high fault exists. The comparator 960 compares the voltage at the HSD node 935 with a low limit 950 (possibly a fixed voltage relative to ground and/or SDV, e.g., 0.5V) to generate a low fault bit of, for example, logical level 1 if no low fault exists. The latches (D flip flops) 965 and 970 latch the high and low fault bits to the HSD open/short register 250. Accordingly, a 01 value represents no fault, a 00 value indicates a low fault, and a 11 value indicates a high fault.

In one embodiment, the HSD node 935 is coupled to the node between the HSD 175 and the squib 180 of the squib circuit 135 of FIG. 1, i.e., node X. Thus, in operation, when the HSD 175 and LSD 185 are in proper working order, the voltage at node X should be somewhere above ground (e.g., 0.5V) and below SDV (e.g., 4.5V). If there is a short from node X to SDV, then the voltage at HSD node 935 would be equal to SDV. If there is a short from node X to ground or node X is floating, then the voltage at the HSD node 935 would be equal to ground. The values generated by the open/short diagnostic circuit 930 when testing the HSD 175 are stored in the HSD open/short register 250. In one embodiment, all channels are scanned simultaneously for both HSD open and short conditions.

For testing the low side driver 185, the open/short diagnostic circuit 930 includes an LSD node 935 coupled in parallel to an LSD pull-up resistor R21 (with the HSD pull-down resistor R22 shown in the figure connected through the squib resistance via the HSD node) and to a window comparator 985 comprised of two comparators 955 and 960. The comparator 955 compares the voltage at the LSD node 935 with a high limit 945 (possibly a fixed voltage relative to SDV, e.g., 4.5V) to generate an high fault bit of, for example, logical level 0 if no high fault exists. The comparator 960 compares the voltage at the LSD node 935 with a low limit 950 (possibly a fixed voltage relative to ground and/or SDV, e.g., 0.5V) to generate a low fault bit of, for example, logical level 1 if no low fault exists. The latches (D flip flops) 965 and 970 latch the high and low fault bits to the LSD open/short register 252. Accordingly, a 01 value represents no fault, a 00 value indicates a low fault, and a 11 value indicates a high fault.

In one embodiment, the LSD node 935 is coupled to the node between the squib 180 and the LSD 185 of the squib circuit 135 of FIG. 1, i.e., node Y. Thus, in operation, when the HSD 175 and LSD 185 are in proper working order, the voltage at node Y should be somewhere above ground (e.g., 0.5V) and below SDV (e.g., 4.5V). If there is a short from node Y to SDV or node Y is floating, then the voltage at node 935 would be equal to SDV. If there is a short from node Y to ground, then the voltage at the LSD node 935 would be equal to ground. The values generated by the open/short diagnostic circuit 930 when testing the LSD 185 are stored in the LSD open/short register 252. In one embodiment, all channels are scanned simultaneously for both LSD open and short conditions.

FIG. 9B is a circuit diagram illustrating details of an open/short error reporting module 900, in accordance with an embodiment of the present invention. The open/short error reporting module 900 includes logic 905 connected to the HSD/LSD open/short register 910, e.g., one of the HSD open/short register 250 and/or the LSD open/short register 252. As stated above, the HSD/LSD open/short register 250/252 stores pairs of low and high fault status bits for all squib circuits 135, namely, xSD1-xSD8 (wherein 00=lo fault, 01=ok, and 11=hi fault). The logic 905 includes an XNOR gate for performing a logical XNOR function on each pair of low and high fault bits to generate a single bit indicative of an HSD/LSD open/short error generally within the corresponding squib circuit 135, regardless of high or low fault type. The output of each XNOR gate are coupled to an OR gate to perform a logical OR function to generate a single bit indicative of an open/short fault generally in any of the squib circuits 135, regardless of the identify of the squib circuit 135. The output of the OR gate is coupled to the device fault register 230.

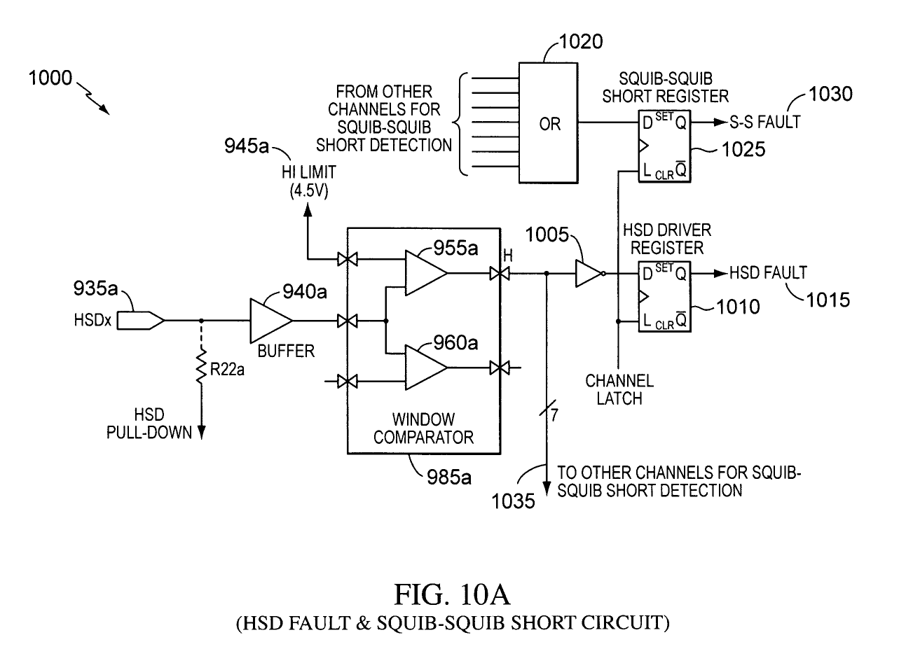

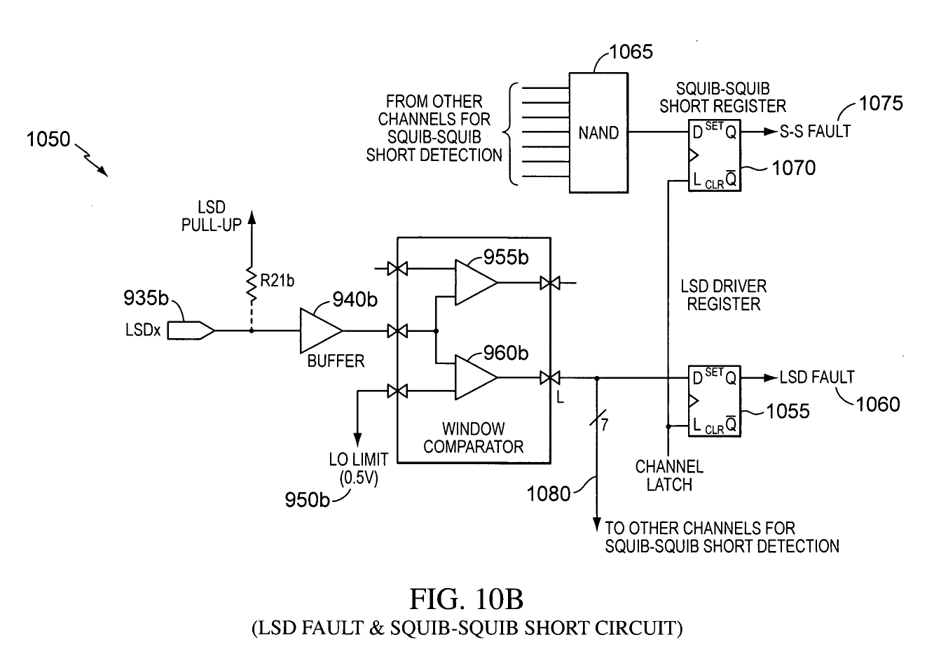

FIG. 10A is a circuit diagram illustrating details of an HSD fault and squib-squib short diagnostic circuit 1000, in accordance with an embodiment of the present invention. In one embodiment, the HSD fault and squib-squib short diagnostic circuit 1000 uses a portion of the open/short diagnostic circuit 930. Similar elements in FIG. 10A are labeled with the same reference numbers as FIG. 9A appended with an “a” for convenience. The HSDx node 935a remains coupled to node X. The HSD fault and squib-squib short diagnostic circuit 1000 further includes an inverter 1005 coupled to the output of comparator 955a, and a D flip flop 1010 coupled to the inverter 1005. In another embodiment, the squib-squib short diagnostic circuit portion can operate without and/or independently of the HSD fault diagnostic circuit portion.

In one embodiment, each HSD 175 is tested individually in sequence for proper operation. All LSDs 185 in the squib driver module 120 are disabled (inhibited). Then, each HSD 175 is turned on in a current limited mode, where the current provided is sufficient to turn on the HSD 175 but insufficient to fire any squib 180. In one embodiment, activating the HSD 175 may be effected by applying a test voltage to the HSD 175 input (e.g., MOSFET gate) to generate a diagnostic current through the HSD 175 (e.g., between MOSFET drain and source). Activation of the HSD 175 should pull the voltage to SDV at node X, unless the HSD 175 is not operating properly. The output of the comparator 955a compares the voltage at node X against a fixed limit below SDV and above the static node X voltage, e.g., 4.5V, and provides a logical level 1 if no HSD 175 fault exists (in contrast with the open/short diagnostic sequence which provides a logical level 0 if no fault exists). The inverter 1005 inverts the result for consistency (so that a logical level 0 indicates no HSD fault), and the D flip flop 1010 latches the result. The latched result, i.e., the HSD fault 1015, is stored in the HSD & LSD driver registers 254 described below.

At the same time as the HSD diagnostic sequences are being performed, the HSD fault and squib-squib short diagnostic circuit 1000 may also monitor for squib-squib shorts. During the HSD 175 test, the HSD fault and squib-squib short diagnostic circuit 1000 can monitor all other nodes X of all other squib circuits 135. If the HSD fault and squib-squib short diagnostic circuit 1000 observes a high condition on any other node X of any other squib circuit 135, the HSD fault and squib-squib short diagnostic circuit 1000 determines that a squib-to-squib short condition exists. In one embodiment, the HSD fault and squib-squib short diagnostic circuit 1000 uses an OR gate 1020 to perform a logical OR function of the logical output values from the comparators 955a of the HSD fault and squib-squib short diagnostic circuits 1000 attached to the other squib circuits 135, and uses a D flip flop 1025 to latch the squib-squib fault 1030 and forward it to the squib-squib short register 256. As shown in this circuit 1000, the output of the comparator 955a (before the inverter 1005) is coupled via connections 1035 to the OR gates 1020 of the HSD fault and squib-squib short diagnostic circuits 1000 attached to the other squib circuits 135. By monitoring all squib driver nodes X during HSD diagnostic testing, squib-to-squib shorts can be detected simultaneously with the HSD diagnostics, instead of as a separate diagnostic sequence.

FIG. 10B is a circuit diagram illustrating details of an LSD fault and squib-squib short diagnostic circuit 1050, in accordance with an embodiment of the present invention. In one embodiment, the LSD fault and squib-squib short diagnostic circuit 1050 uses a portion of the open/short diagnostic circuit 930. Similar elements in FIG. 10B are labeled with the same reference numbers as FIG. 9A appended with a “b” for convenience. The LSDx node 935b remains coupled to node Y. The LSD fault and squib-squib short diagnostic circuit 1050 further includes a D flip flop 1055 coupled to the output of the comparator 960b. In another embodiment, the squib-squib short diagnostic circuit portion can operate without and/or independently of the LSD fault diagnostic circuit portion.

In one embodiment, each LSD 185 is tested individually in sequence for proper operation. All HSDs 175 in the squib driver module 120 are disabled (inhibited). Then, each LSD 185 is turned on in a current limited mode, where the current provided is sufficient to turn on the LSD 185 but insufficient to fire any squib 180. In one embodiment, activating the LSD 185 may be effected by applying a test voltage to the LSD 185 input (e.g., MOSFET gate) to generate a diagnostic current through the LSD 185 (e.g., between MOSFET drain and source). Activation of the LSD 185 should pull the voltage to ground at node Y, unless the LSD 185 is not operating properly. The output of the comparator 960b compares the voltage at node Y against a fixed limit above ground and below the static node Y voltage, e.g., 0.5V, and provides a logical level 0 if no LSD 185 fault exists (in contrast with the open/short diagnostic sequence which provides a logical level 1 if no fault exists). In one embodiment, no inverter is needed since the indication is consistent with the other diagnostic circuits. The D flip flop 1055 latches the result. The latched result, i.e., the LSD fault 1060, is stored in the HSD & LSD driver registers 254 described below.

At the same time as the LSD diagnostic sequences are being performed, the LSD fault and squib-squib short diagnostic circuit 1050 may also monitor for squib-squib shorts. During the LSD 185 test, the LSD fault and squib-squib short diagnostic circuit 1050 can monitor all other nodes Y of all other squib circuits 135. If the LSD fault and squib-squib short diagnostic circuit 1050 observes a low condition on any other node Y of any other squib circuit 135, the LSD fault and squib-squib short diagnostic circuit 1050 determines that a squib-to-squib short condition exists. In one embodiment, the LSD fault and squib-squib short diagnostic circuit 1050 uses a NAND gate 1065 to perform a logical NAND function of the logical output values from the comparators 960b of the LSD fault and squib-squib short diagnostic circuits 1500 attached to the other squib circuits 135, and uses a D flip flop 1070 to latch the squib-squib fault 1075 and forward it to the squib-squib short register 256. As shown in this circuit 1050, the output of the comparator 960b is coupled via connections 1080 to the NAND gates 1065 of the LSD fault and squib-squib short diagnostic circuits 1050 attached to the other squib circuits 135. By monitoring all squib driver nodes Y during LSD diagnostic testing, squib-to-squib shorts can be detected simultaneously with the LSD diagnostics, instead of as a separate diagnostic sequence.

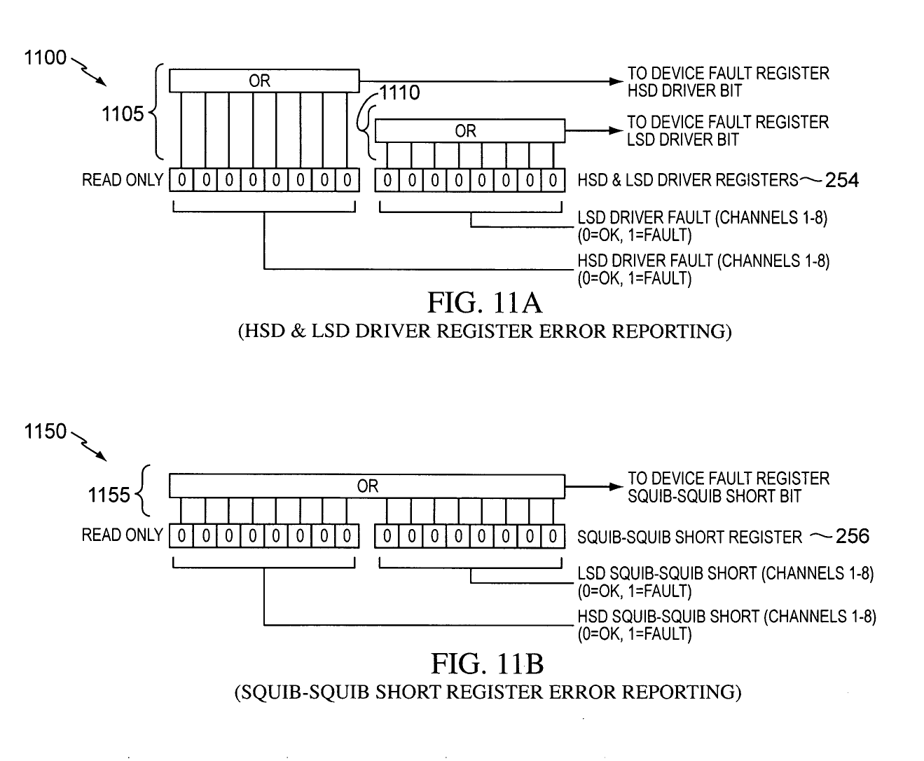

FIG. 11A is a circuit diagram illustrating details of an HSD/LSD driver error reporting module 1100, in accordance with an embodiment of the present invention. The HSD/LSD driver error reporting module 1100 includes logic 1105 and logic 1110 coupled to the HSD and LSD driver registers 254 for determining whether an HSD or LSD fault exists, generally. In one embodiment, the first 8 bits define the eight HSD driver faults 1015 for each squib circuit 135, and the second 8 bits define the eight LSD driver faults 1060 for each squib circuit 135. The logic 1105 generates a single HSD driver fault bit, which it sends to the device fault register 230. The logic 1110 generates a single LSD driver fault bit, which it sends to the device fault register 230. In one embodiment, each of the logic 1105 and the logic 1110 includes an OR gate.

FIG. 11B is a circuit diagram illustrating details of a squib-squib short error reporting module 1150, in accordance with an embodiment of the present invention. The squib-squib short error reporting module 1150 includes logic 1155 coupled to the squib-squib short register 256 for determining whether a squib-squib short exists, generally. In one embodiment, the first 8 bits define the eight HSD squib-squib short faults 1030 for each squib circuit 135, and the second 8 bits define the eight LSD squib-squib short faults 1075 for each squib circuit 135. The logic 1155 generates a single squib-squib short fault bit, which it sends to the device fault register 230. In one embodiment, the logic 1155 includes an OR gate.

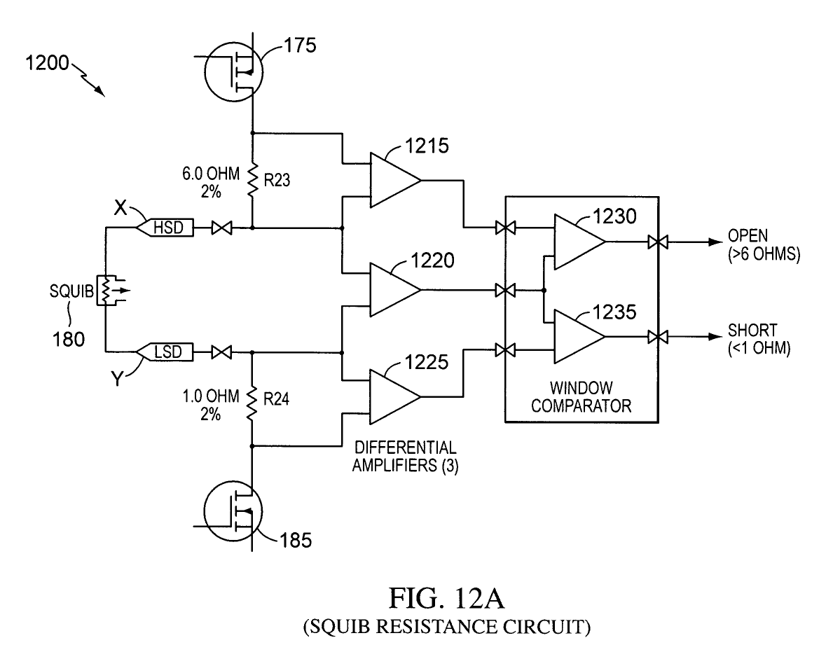

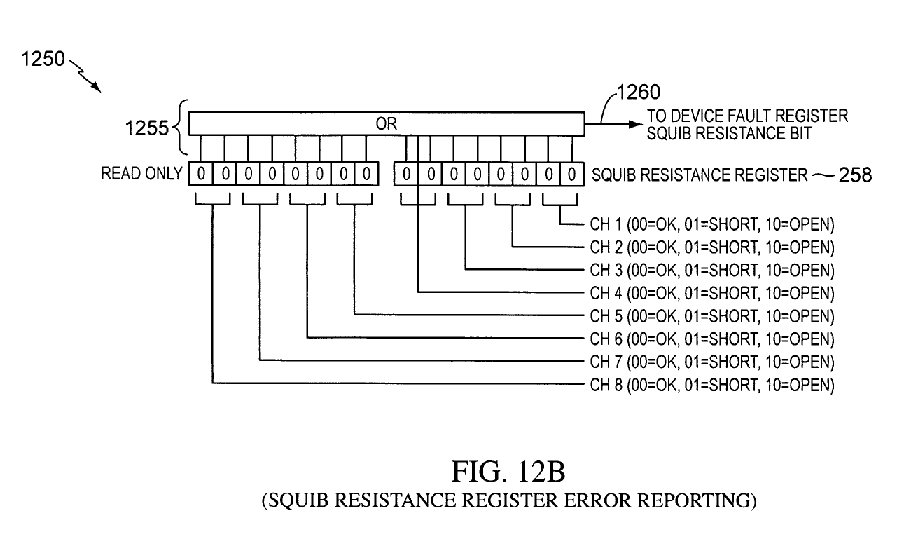

FIG. 12A is a circuit diagram illustrating details of a squib resistance diagnostic circuit 1200, in accordance with an embodiment of the present invention. The squib resistance diagnostic circuit 1200 includes a small resistor R23 equal to maximum acceptable resistance of the squib 180 (e.g., 6.0 ohms) coupled in series between HSD 175 and squib 180, and a small resistor R24 equal to the minimum resistance of the squib 180 (e.g., 1.0 ohm) coupled in series between squib 180 and LSD 185. In one embodiment, the resistors R23 and R24 are programmable and can be adjusted via SPI commands. The squib resistance diagnostic circuit 1200 includes a first differential amplifier 1215 to measure the voltage across the first resistor R23, a second differential amplifier 1220 to measure the voltage across the squib 180, and a third differential amplifier 1225 to measure the voltage across the second resistor R24. The squib resistance diagnostic circuit 1200 includes a first comparator 1230 that measures the voltage between the output of the first differential amplifier 1215 and the output of the second differential amplifier 1220, and a second comparator 1235 that measures the voltage between the output of the second differential amplifier 1220 and the third differential amplifier 1225.

A small diagnostic current is applied to resistors R23 and R24 and to squib 180 in a serial manner. This diagnostic current is chosen to be insufficient to fire the squib 180. As the same current flows through the resistors R23 and R24 and the squib 180, a direct comparison can be made to determine if the squib 180 resistance is within the acceptable range and a fault can be generated if the squib 180 voltage is outside the range. That is, the first comparator 1230 compares the squib 180 voltage against the maximum squib 180 voltage (generated by the resistor R23) to generate a logic level 0 when in range. The second comparator 1235 compares the squib 180 voltage against the minimum squib 180 voltage (generated by the resistor R24) to generate a logic level 0 when in range. If the squib 180 voltage is greater than the maximum voltage across the resistor R23, then the first comparator 1230 output will be a logic level 1, representing an open circuit fault. If the squib 180 voltage is less than the minimum voltage across the resistor R24, then the second comparator 1235 output will be a logic level 1, representing a short circuit fault. The faults will be sent to the squib resistance register 258. Accordingly, a 00=ok, a 10=open, and a 01=short. In one embodiment, squib resistance for each firing loop is diagnosed sequentially for each channel.

FIG. 12B is a circuit diagram illustrating details of a squib resistance error reporting module 1250, in accordance with an embodiment of the present invention. The squib resistance error reporting module 1250 includes logic 1255 for reading the fault data stored in the squib resistance register 258 and generating a squib resistance diagnostic fault bit 1260 that represents a squib resistance fault generally, regardless of location or open/short type. In one embodiment, the fault data is stored in the squib resistance register 258 such that a 00=ok, a 01=short, and a 10=open. In one embodiment, the logic 1255 includes an OR gate for performing an OR function on the fault data in the squib resistance register 258.

Squib resistance is typically performed with multiple measurements using an A/D converter to remove error factors and increase accuracy. By measuring voltage drop across serial elements simultaneously, most error factors are removed and the direct comparison eliminates the need for an A/D converter.

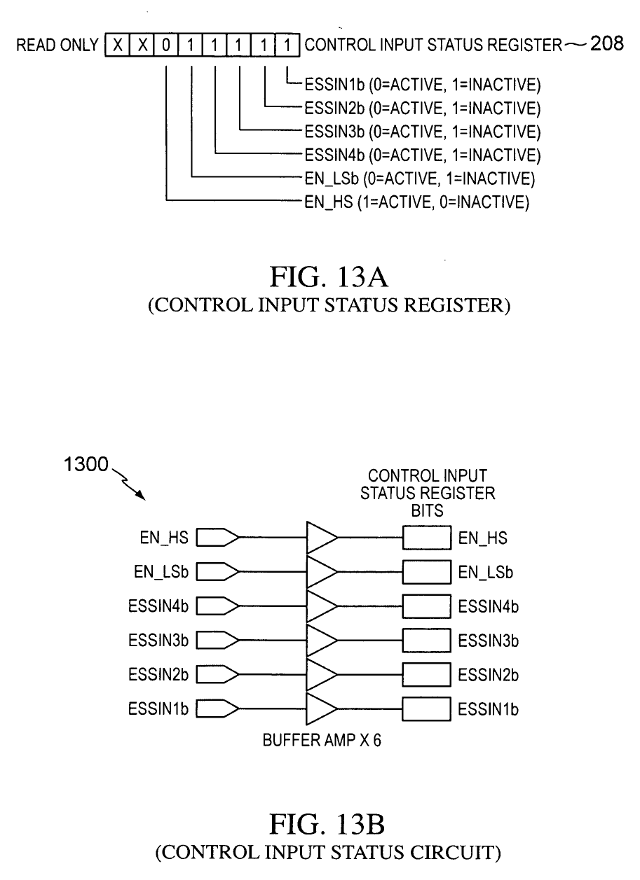

FIG. 13A is a circuit diagram illustrating details of the control input status register 208, in accordance with an embodiment of the present invention. The control input status register 208 reports the logic level of control input pins, including ESSIN1b (0=active, 1=inactive), ESSIN2b (0=active, 1=inactive), ESSIN3b (0=active, 1=inactive), ESSIN4b (0=active, 1=inactive), EN_LSb (0=active, 1=inactive), and EN_HS (1=active, 0=inactive).

FIG. 13B is a circuit diagram illustrating details of a control input status circuit 1300, in accordance with an embodiment of the present invention. Control input status circuit 1300 may include a buffer stage having individual buffer amplifiers for each circuit.

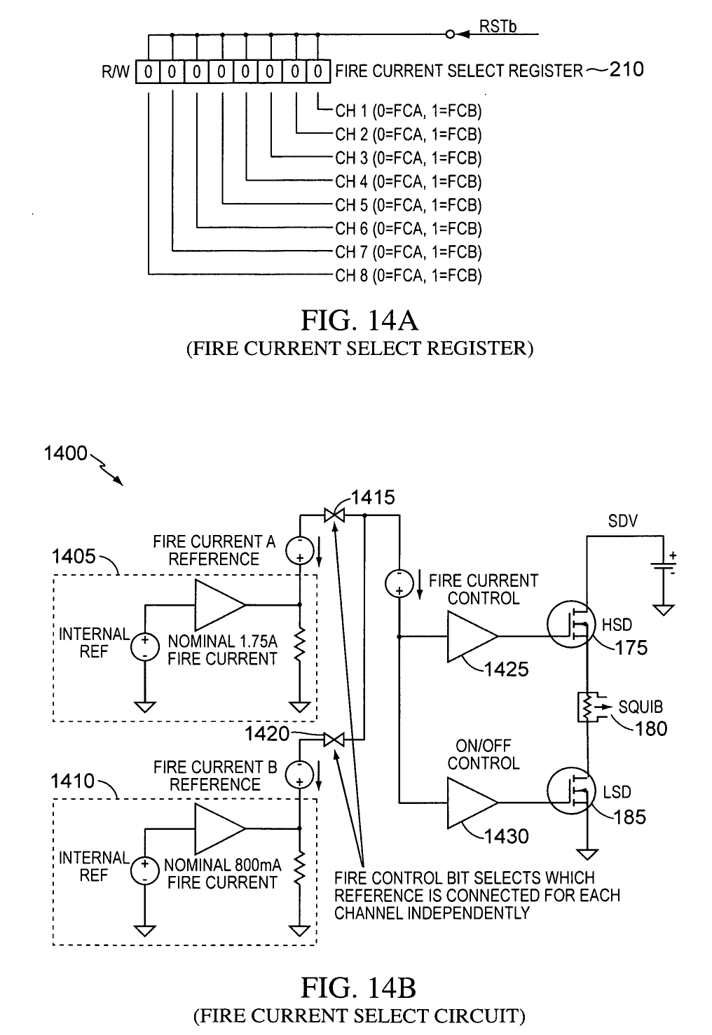

FIG. 14A is a block diagram illustrating details of the fire current select register 212, in accordance with an embodiment of the present invention. The fire current select register 212 may include 8 channels for eight squib circuits 135, such that each bit represents whether to use fire current A (FCA), e.g., 800 mA, or fire current B (FCB), e.g., 1.75 A. In one embodiment, a logic level 0=FCA, and a logic level 1=FCB.

FIG. 14B is a circuit diagram illustrating details of a fire current select circuit 1400, in accordance with an embodiment of the present invention. Fire current select circuit 1400 includes an FCA circuit 1405 coupled via a switch 1415 to a fire current control 1425 that operates to activate the HSD 175, and via the switch 1415 to an on/off control 1430 that operates to activate the LSD 185. The fire current select circuit 1400 also includes an FCB circuit 1410 coupled via a switch 1420 to the fire current control 1425 that operates to activate the HSD 175, and via the switch 1420 to the on/off control 1430 that operates to activate the LSD 185. Control bits of the fire current select register 210 determine whether the switch 1415 or the switch 1420 is activated. In one embodiment, the reset state of the fire current select register 210 will be to fire current A (bit set to logic level 0). The bits of the fire current select register 210 may be set via an SPI command.

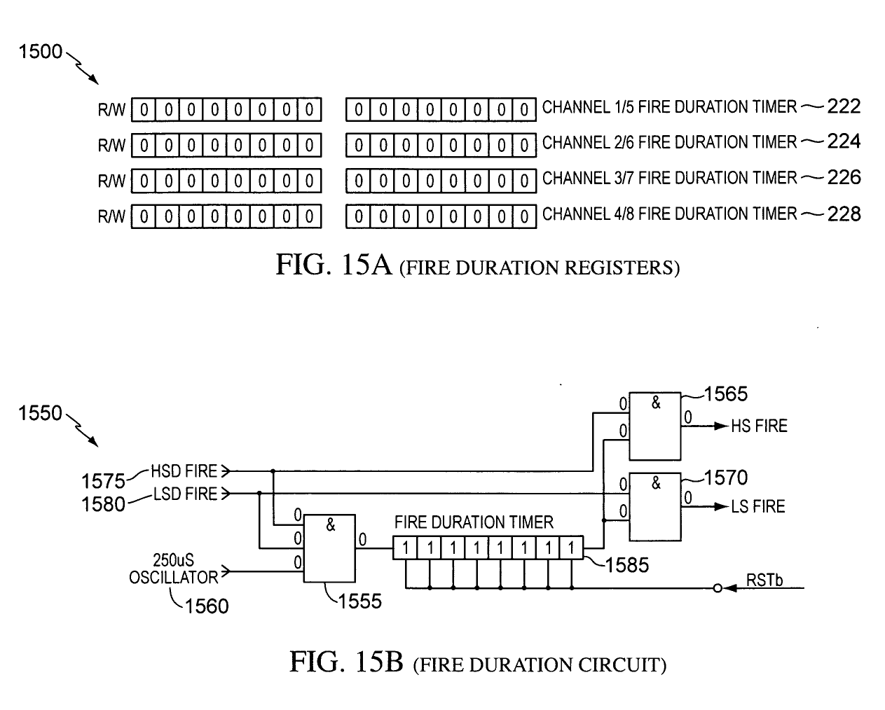

FIG. 15A is a block diagram illustrating details of the fire duration timer registers 1500, in accordance with an embodiment of the present invention. In one embodiment, the fire duration registers 1500 include a channel 1/5 fire duration timer register 222, a channel 2/6 fire duration timer register 224, a channel 3/7 fire duration timer register 226, and a channel 4/8 fire duration timer register 228. Each fire duration register 222, 224, 226 and 228 represents the specified duration for the squib firing current. In one embodiment, each count in the fire duration timer represents 250 microseconds of fire duration time. The quantity, data width, order and organization of fire duration registers is determined by the application.

FIG. 15B is a circuit diagram illustrating details of a fire duration circuit 1550, in accordance with an embodiment of the present invention. The fire duration circuit 1550 includes a first three-input AND gate 1555. The three inputs include an HSD fire command 1575, an LSD fire command 1580 and a 250 microsecond oscillation signal 1560 (from an 250 microsecond oscillator). The output of the AND gate 1555 causes the fire duration timer 1585 (e.g., the fire duration timer 222, 224, 226 and 228) to shift the bits therein to a first two-input AND gate 1565 and a second two-input AND gate 1570. The first two-input AND gate 1565 performs an AND function on the HSD fire command and the bit received from the three-input AND gate 1555 to generate the HS fire command. The second two-input AND gate 1570 performs an AND function on the LSD fire command and the bit received from the three-input AND gate 1555 to generate the LS fire command. That way, each high bit in the fire duration timer 1585 causes fire current to be generated for 250 microseconds. In one embodiment, a reset command sent to the fire duration register 1585 causes the all the bits to be reset to the maximum fire duration (all 1's).

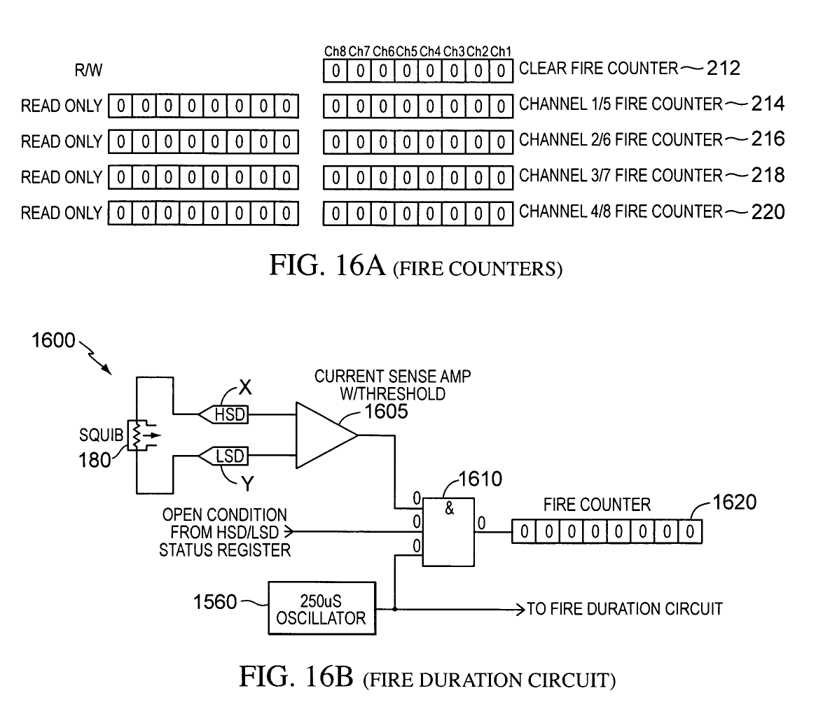

FIG. 16A is a block diagram illustrating details of the fire counter registers 214, 216, 218 and 220 and the clear fire counter register 212, in accordance with an embodiment of the present invention. Each fire counter register 214, 216, 218, 220 indicates the total time duration that the corresponding channel delivered minimum fire current to the squib 180. In one embodiment, each fire counter 214, 216, 218, 220 has eights bits. Each count in the fire counter 214, 216, 218, 220 is weighted at 250 microseconds of fire current duration. The clear fire counter register 212 includes read/write functionality, and indicates whether to clear the corresponding fire counter register 214, 216, 218, 220. In one embodiment, the individual channel counters 214, 216, 218, 220 can be cleared by writing a logic level 1 to the appropriate bit in the clear fire counter register 212.

FIG. 16B is a circuit diagram illustrating details of a fire counter circuit 1600, in accordance with an embodiment of the present invention. The fire counter circuit 1600 includes a three-input AND gate 1610 that receives at a first input the output of a current sense amplifier 1605 sensing the current through the squib 180 compared against a threshold, at a second input a bit from the HSD/LSD status register indicative of an open condition, and at a third input the 250 microsecond oscillator signal from the 250 microsecond oscillator 1560 (see FIG. 15B).

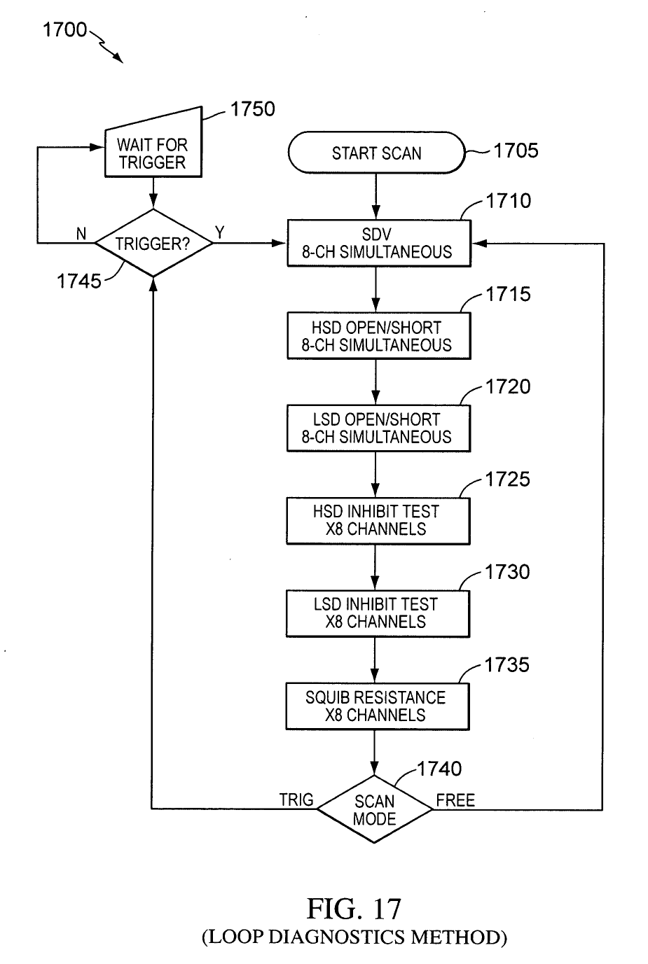

FIG. 17 is a flowchart illustrating a method 1700 of conducting squib driver circuit (loop) diagnostics, in accordance with an embodiment of the present invention. Method 1700 may be enabled by a state machine. Method 1700 begins with the test control circuit 150 at step 1705 initiating the scanning process. Each SDV status diagnostic circuit 700 of each channel (i.e., squib circuit 135) in step 1710 simultaneously conducts a diagnostic test to confirm that the corresponding SDV is within proper range. Any identified diagnostic fault is sent to the appropriate diagnostic register(s) 204. Each HSD open/short circuit 930 of each channel in step 1715 simultaneously conducts a diagnostic test to confirm that the corresponding HSD 175 does not have an open or short fault. Again, any identified diagnostic fault is sent to the appropriate diagnostic register(s) 204. Each LSD open/short circuit 930 of each channel in step 1720 simultaneously conducts a diagnostic test to confirm that the corresponding LSD 185 does not have an open or short fault. Again, any identified diagnostic fault is sent to the appropriate diagnostic register(s) 204. Sequentially, each HSD fault and squib-squib short diagnostic circuit 1000 of each channel in step 1725 conducts simultaneous HSD fault and squib-squib short diagnostic tests, while inhibiting the LSD 185 operation, to confirm that the corresponding HSD 175 is functioning properly and that there is no squib-squib short. Again, any identified diagnostic fault is sent to the appropriate diagnostic register(s) 204. Sequentially, each LSD fault and squib-squib short diagnostic circuit 1050 of each channel in step 1730 conducts simultaneous LSD and squib-squib short diagnostic tests, while inhibiting the HSD 175 operation, to confirm that the corresponding LSD 185 is operating properly and that there is no squib-squib short. Again, any identified diagnostic fault is sent to the appropriate diagnostic register(s) 204. Sequentially, each squib resistance circuit 1200 of each channel in step 1735 conducts a diagnostic check to confirm that the corresponding squib 180 resistance is within a proper range. Again, any identified diagnostic fault is sent to the appropriate diagnostic register(s) 204. The test control module 150 in step 1740 determines the scan mode. If determined to be set to free-running mode, then the method 1700 returns to step 1710 to continuously initiate another scan. If determined to be set to trigger mode, then the method 1700 jumps to step 1745. In step 1745, the test control module 150 determines whether a trigger has been received, e.g., from the fault check module 165 of the airbag ECM MPU 105 or from internal circuitry, e.g., an internal state machine. When a trigger is received, then the method 1700 returns to step 1710 to initiate another scan.

One embodiment of the invention incorporates squib diagnostic circuits 170 into the squib driver module 120 instead of relying on an external MPU. A state machine may be embedded into the squib diagnostic circuits 170, so that the diagnostics may run autonomously. Other customer-specific diagnostics can be incorporated into the squib diagnostic circuits 170 and scan sequence as desired, with the same mode of operation and masking capabilities. Since EMI can radiate when certain diagnostic tests are performed, controlling operating scan frequency and the mode of operation and allowing independent control over the operation of radiating diagnostics can reduce the effects of the electromagnetic emissions on surrounding circuitry. Since the squib diagnostic circuits 170 are incorporated into the squib driver module 120, an external controlling element and A/D circuitry may not be required. Further, when testing squib circuits 135, the actual circuit elements instead of a separate alternative path may be tested, thus validating the actual firing path. An MCU 105, if attached, can read the fault condition directly without further calculation or interpretation.

MCU 105 overhead in the airbag ECU may be reduced by several techniques. For example, diagnostics may be performed continuously on the squib driver module 120 independent of MCU 105 intervention. An error signal may be generated and presented on an MCU interrupt to signal that a fault condition has occurred. A fault register 230 may be maintained on the squib device module 120, wherein each bit refers to the overall status of a specific diagnostic. Any faults that may be exist may be represented by activating a corresponding bit in the device fault register 230. The register 230 can be read at any time by the MCU 105, providing an overall status of all channels of the squib device module 120 with a single read command. The diagnostic scan process can be operated in either a continuous scan or triggered (single scan) mode. Further, the scan sequence can be paused at any point by entering an inhibit mode, either by asserting an external control pin or via SPI command. Once inhibit is released, the scan continues from where it left off.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A squib driver module comprising:
a squib circuit for deploying a squib, the squib circuit including a high side driver and a low side driver in combination for driving a firing signal to the squib;
a control circuit coupled to the squib circuit for activating the firing signal in response to a firing condition by sending an HSD control signal to the high side driver and an LSD control signal to the low side driver;
squib diagnostic circuits coupled to the high side driver and to the low side driver for conducting diagnostic tests without activating the firing signal to the squib and without delivering a diagnostic signal equivalent of the firing signal to the squib, the squib diagnostic circuits for generating digital fault information based on the diagnostic tests;
diagnostic registers for storing the digital fault information;
logic for recognizing a fault condition based on the digital fault information; and
a communication module for communicating the fault condition over a communication channel to a microprocessor unit.

2. The system of claim 1, wherein the squib is located in an airbag assembly.

3. The system of claim 1, wherein the high side driver includes a first transistor, the low side driver includes a second transistor, and the firing signal includes a firing current.

4. The system of claim 1, wherein the squib diagnostic circuits include a node voltage status diagnostic circuit for determining whether a node in the squib circuit is operating within a predetermined voltage range.

5. The system of claim 4, wherein the node voltage status diagnostic circuit is operative to determine whether a supply voltage coupled to the high side driver is operating within a predetermined supply voltage range.

6. The system of claim 1, wherein the squib diagnostic circuits include an HSD open/short diagnostic circuit for using a pull-down device to determine whether the high side driver has an open/short fault.

7. The system of claim 1, wherein the squib diagnostic circuits include an LSD open/short diagnostic circuit for using a pull-up device to determine whether the low side driver has an open/short fault.

8. The system of claim 1, wherein the squib diagnostic circuits include an HSD driver fault diagnostic circuit for disabling the low side driver, for providing a test signal to the high side driver to activate a diagnostic signal through the high side driver, the diagnostic signal being less than a minimum signal to deploy the squib, and for measuring a generated voltage to determine whether the high side driver is functioning properly.

9. The system of claim 8, wherein the squib driver module includes a second squib circuit for deploying a second squib, and squib diagnostic circuits include a squib-squib short diagnostic circuit for determining substantially simultaneously with the HSD driver fault diagnostic circuit whether a squib-squib short exists.

10. The system of claim 1, wherein the squib diagnostic circuits include an LSD driver fault diagnostic circuit for disabling the high side driver, for providing a test signal to the low side driver to activate a diagnostic signal through the low side driver, the diagnostic signal being less than a minimum signal to deploy the squib, and for measuring a generated voltage to determine whether the low side driver is functioning properly.

11. The system of claim 10, wherein the squib driver module includes a second squib circuit for deploying a second squib, and the squib diagnostic circuits include a squib-squib short diagnostic circuit for determining substantially simultaneously with the LSD driver fault diagnostic circuit whether a squib-squib short exists.

12. The system of claim 1, wherein the squib driver module includes a second squib circuit for deploying a second squib, and the squib diagnostic circuits include an HSD squib-squib short diagnostic circuit for disabling the low side driver, for providing a test signal to the high side driver to activate a diagnostic signal through the high side driver, and for comparing generated voltages at the first squib and the second squib to determine if a squib-squib short exists.

13. The system of claim 1, wherein the squib driver module includes a second squib circuit for deploying a second squib, and the squib diagnostic circuits include an LSD squib-squib short diagnostic circuit for disabling the high side driver, for providing a test signal to the low side driver to activate a diagnostic signal through the low side driver, and for comparing generated voltages at the first squib and the second squib to determine if a squib-squib short exists.

14. The system of claim 1, wherein the squib diagnostic circuits include a squib resistance diagnostic circuit for determining whether a squib resistance is within a predetermined squib resistance range.

15. The system of claim 1, wherein the communication module includes an SPI module.

16. The squib driver module of claim 1, wherein the logic and the communication module operate to automatically forward the fault condition to the microprocessor unit.

17. A method in a squib driver module, the method comprising:
determining whether a firing condition for deploying a squib has been satisfied;
if the firing condition has been satisfied,
causing a squib circuit to generate a firing signal to the squib; and
if the firing condition has not been satisfied,
initiating a squib diagnostic circuit coupled to the squib circuit to perform a diagnostic scan of the squib circuit;
generating by the squib diagnostic circuit digital diagnostic fault information indicative of a fault status;
storing the digital diagnostic fault information in a local register; and
sending the fault status to an external microprocessor unit at least if a fault is diagnosed.

18. The method of claim 17, wherein the determining whether the firing condition has been satisfied includes receiving an activation signal from a sensor and determining that the local register stores diagnostic fault information indicating no faults.

19. The method of claim 17, wherein the initiating occurs based on a trigger mode.

20. The method of claim 17, wherein the initiating occurs based on a free-running mode.

21. The method of claim 17, wherein the squib diagnostic circuit includes a node voltage status diagnostic circuit, and the generating includes determining whether a node in the squib circuit is operating within a predetermined voltage range.

22. The method of claim 21, wherein the node includes a supply voltage.

23. The method of claim 17, wherein the squib diagnostic circuit includes an open/short diagnostic circuit, and wherein the generating includes using a pull-down device to determine whether the squib circuit has an open/short fault.

24. The method of claim 23, wherein the squib diagnostic circuit includes an open/short diagnostic circuit, and the generating includes using a pull-up device to determine whether the squib circuit has an open/short fault.

25. The method of claim 17, wherein
the squib circuit includes a high side driver and a low side driver in combination for generating the firing signal,
the squib diagnostic circuit includes an HSD driver fault diagnostic circuit, and
the generating includes disabling the low side driver, providing a test signal to the high side driver to activate a diagnostic signal through the high side driver, the diagnostic signal being less than a minimum signal to deploy the squib, and measuring a generated voltage to determine whether the high side driver is functioning properly.

26. The method of claim 25, wherein the squib diagnostic circuit further includes a squib-squib short diagnostic circuit, and the generating further includes using the squib-squib short diagnostic circuit to determine substantially simultaneously with the HSD driver fault diagnostic circuit whether a squib-squib short exists.

27. The method of claim 17, wherein
the squib circuit includes a high side driver and a low side driver in combination for generating the firing signal,
the squib diagnostic circuit include an LSD driver fault diagnostic circuit, and
the generating includes disabling the high side driver, providing a test signal to the low side driver to activate a diagnostic signal through the low side driver, the diagnostic signal being less than a minimum signal to deploy the squib, and measuring a generated voltage to determine whether the low side driver is functioning properly.

28. The method of claim 17, wherein the squib diagnostic circuit further includes a squib-squib short diagnostic circuit, and the generating further includes using the squib-squib short diagnostic circuit to determine substantially simultaneously with the LSD driver fault diagnostic circuit whether a squib-squib short exists.

29. The method of claim 17, wherein
the squib circuit includes a high side driver and a low side driver in combination for generating the firing signal,
the squib diagnostic circuit includes an HSD squib-squib short diagnostic circuit, and
the generating includes disabling the low side driver, providing a test signal to the high side driver to activate a diagnostic signal through the high side driver, and comparing generated voltages at the squib and a second squib to determine if a squib-squib short exists.

30. The method of claim 17, wherein
the squib circuit includes a high side driver and a low side driver in combination for generating the firing signal,
the squib diagnostic circuit includes an LSD squib-squib short diagnostic circuit, and
the generating includes disabling the high side driver, providing a test signal to the low side driver to activate a diagnostic signal through the low side driver, and comparing generated voltages at the squib and a second squib to determine if a squib-squib short exists.

31. The method of claim 17, wherein the squib diagnostic circuit includes a squib resistance diagnostic circuit, and the generating includes determining whether a squib resistance is within a predetermined squib resistance range.

32. A squib driver module, comprising:
means for determining whether a firing condition for deploying a squib has been satisfied;
means for causing a squib circuit to generate a firing signal to the squib if the firing condition has been satisfied;
means for initiating a squib diagnostic circuit coupled to the squib circuit to perform a diagnostic scan of the squib circuit if the firing condition has not been satisfied, the squib diagnostic circuit for generating by the squib diagnostic circuit digital diagnostic fault information indicative of a fault status;
local register means for storing the digital diagnostic fault information; and
means for sending the fault status to an external microprocessor unit at least if a fault is diagnosed.

33. An electronic controller module, comprising:
a microprocessor unit;
a squib-controlled device including a squib;
a controller for recognizing a firing condition; and
a squib driver module coupled to the microprocessor unit and to the squib-controlled device, the squib driver module including
a squib circuit for deploying a squib, the squib circuit including a high side driver and a low side driver in combination for driving a firing signal to the squib;
a control circuit coupled to the squib circuit for activating the firing signal in response to a firing condition by sending an HSD control signal to the high side driver and an LSD control signal to the low side driver;
squib diagnostic circuits coupled to the high side driver and to the low side driver for conducting diagnostic tests without activating the firing signal to the squib and without delivering a diagnostic signal equivalent of the firing signal to the squib, the squib diagnostic circuits for generating digital fault information based on the diagnostic tests;
diagnostic registers for storing the digital fault information;
logic for recognizing a fault condition based on the digital fault information; and
a communication module for communicating the fault condition over a communication channel to a microprocessor unit.
